(19) United States
(12) Patent Application Publication
(10) Pub. No.: US 2026/0308322 A1
(43) Pub. Date: Oct. 8, 2026

(54) Integrated System and Process for Producing High Performance Polyamides from Circular Components

(71) Applicant: Celanese Polymers Holding, Inc., Wilmington, DE (US)

(72) Inventors: Michael Chisholm, Newark, DE (US); Jacob Dickinson, Huntington Woods, MI (US); Shailesh Doshi, Kingston, Ontario (CA); Stephan Eilbracht, Prevessin-Moens (FR)

(21) Appl. No.: 19/429,115

(22) Filed: Dec. 22, 2025

Related U.S. Application Data
(60) Provisional application No. 63/785,041, filed on Apr. 8, 2025.
(60) Provisional application No. 63/878,262, filed on Sep. 9, 2025.

(51) Int. Cl. C08G 69/32; C08G 69/28; C08K 3/016; C08K 7/14

(52) U.S. Cl. CPC C08G 69/32; C08G 69/28; C08K 3/016; C08K 7/14

(57) ABSTRACT

A process is disclosed for producing polyamide polymers from at least one circular atom component. The circular atom component, for instance, can comprise a fluid obtained from biomass or from an industrial waste stream, such as an industrial gas stream that would otherwise be released to the environment. Polyamide polymers, particularly high performance polyamide polymers, are produced not only containing large amounts of circular atoms but also with excellent mechanical and physical properties.

### CROSS REFERENCE TO RELATED APPLICATIONS

This application claims priority to the benefit of U.S. Provisional Application No. 63/785,041, filed Apr. 8, 2025, and U.S. Provisional Application No. 63/878,262, filed Sep. 9, 2025, which are expressly incorporated herein by reference in their entireties.

### BACKGROUND

Polyamide polymer, or nylon, is a synthetic polymer known for its toughness, strength, and elasticity. Polyamide polymer can have a high melting point, good abrasion resistance, and excellent chemical resistance. These properties make polyamide polymer suitable for a wide range of applications.

One group of polyamide polymers are referred to as high performance polyamides which are a class of polyamides engineered to have enhanced mechanical or other properties. The polymers can be formulated to display chemical resistance, flexibility, high temperature resistance, or the like. These resins can be selected for reducing weight, improving strength, enhancing durability, increasing thermal performance and/or simplifying processing.

High performance polyamides are commonly used in all different types of fields and applications. For instance, high performance polyamides are widely used in the automotive industry for components like under-the-hood parts, electrical connectors, and other parts found in high stress environments. High performance polyamides are used in electronics, aerospace, and industrial equipment. As used herein, high performance polyamides include, but are not limited to, polyamide 46, polyamide 9T, polyamide 6T, polyamide 6T/66, polyamide 6T/610, polyamide 6T/6I, polyamide 10T, polyamide 12, polyamide 6T/DT, polyamide 6I/6T, polyamide MXD6, polyamide 610, polyamide 612, and mixtures and copolymers of the above including polyamide 612/6T, polyamide 610/6T, polyamide 9T/910, polyamide 9T/912, polyamide 9T/11, polyamide 9T/12, polyamide 1010, polyamide 10T/11, polyamide 10T/12, polyamide 10T/1010, polyamide 10T/1012, polyamide 10T/46, polyamide 10T/6, polyamide 10T/66, polyamide 12T/1212, polyamide 12T/6, polyamide 12T/66, and the like.

Many high performance polyamides have conventionally been made from fossil-based components. Currently, however, there is a drive to move away from fossil-based materials. In particular, companies are actively seeking ways to reduce usage of fossil feedstocks and lower their carbon emissions.

In view of the above, a need currently exists for one or more processes capable of producing bio-based components for producing high performance polyamide polymers. A need also exists for high performance polyamide polymers that intrinsically contain circular (e.g. renewable or recaptured) atom content.

### SUMMARY

In general, the present disclosure is directed to industrial processes for producing polyamides, particularly high performance polyamides. The polyamide polymers are made from a circular diamine and optionally other circular monomers. The monomers can be produced from a renewable feedstock, such as a renewable natural gas source, in order to incorporate renewable or circular atoms, such as carbon atoms into the polymer structures.

In one aspect, for instance, the present disclosure is directed to a method for producing a polyamide polymer having a circular atom content. The method includes forming a polyamide polymer from a first monomer and a second monomer. The first monomer comprises a diamine. The second monomer comprises an aliphatic diacid containing 4 to 20 carbon atoms, an aromatic diacid containing 8 to 20 carbon atoms, or mixtures thereof. In accordance with the present disclosure, at least a portion of the first monomer is derived from a circular atom component. The circular atom component can comprise a circular natural gas.

In accordance with the present disclosure, the resulting polyamide polymer has a circular atom content of at least about 10% by weight, such as at least about 14% by weight, such as at least about 18% by weight, such as at least about 20% by weight, such as at least about 25% by weight, such as at least about 30% by weight, such as at least about 35% by weight, such as at least about 41% by weight. The circular atom content can be determined according to a suitable circular atom certification process. Circular atom content, in one aspect, can be determined according to the International Sustainability & Carbon Certification (ISCC) rules, ISCC-PLUS v3.4.2 which is incorporated herein by reference. The ISCC certification process is a globally recognized certification system for sustainability, which certifies the chain of custody to track the sustainability characteristics along the supply chain. It covers various sectors, including agriculture, forestry, bioenergy, chemical, and polymer processes. The ISCC certification rules ensure that materials and products are sustainably sourced and processed, reducing environmental impact and promoting social responsibility. The ISCC certification ensures a mass balance approach is properly adopted, which can be used to trace the sustainability of raw materials along the entire supply chain. This involves tracking the amount of certified and non-certified material and ensuring that claims about sustainability can be verified. For example, the method allows for the calculation of the proportion of certified renewable (or circular) content in a mixed batch of materials. During the calculation, carbon and non-carbon atoms can be tracked and incorporated into the calculation. More information regarding the ISCC mass balance approach can be accessed from ISCC: e.g. ISCC EU System Document 202, 2024, https://www.iscc-system.org/process/certification-process/system-documents/, which is incorporated herein by reference.

In one aspect, the circular or renewable natural gas comprises a bio-based methane containing methane in an amount greater than about 80% by weight, such as in an amount greater than about 85% by weight, such as in an amount greater than about 90% by weight, such as in an amount greater than about 95% by weight.

The first monomer comprising the diamine can comprise hexamethylene diamine, decamethylene diamine, or other diamine.

In forming the first monomer, the renewable natural gas can be steam reformed to produce hydrogen which is combined with nitrogen gas to form ammonia. The ammonia can be combined with additional amounts of the renewable natural gas to form hydrogen cyanide. The hydrogen cyanide can be used to form a nitrile, such as adiponitrile, which can be hydrogenated to form the first monomer. The ammonia as described above can be produced according to an endothermic reaction or an exothermic reaction. The adiponitrile can be formed by hydrocyanation of 1,3 butadiene. In one aspect, the 1,3 butadiene can also be formed from a circular carbon component comprising a circular pyrolysis oil, a circular cooking oil, a circular diesel, circular crude tall oil, or a circular naphtha.

In an alternative embodiment, the renewable natural gas can be steam reformed to produce hydrogen which is combined with nitrogen gas to form ammonia. The ammonia is then combined with oxygen and propylene to form a nitrile, such as adiponitrile. The nitrile, such as adiponitrile, can be hydrogenated to form the first monomer. In this embodiment, the propylene can be formed from a circular carbon component such as the renewable natural gas or a circular pyrolysis oil, a circular naphtha, a circular crude tall oil, a circular diesel or another type of circular oil.

In one aspect, the ammonia used in the process comprises blue ammonia, green ammonia, and/or turquoise ammonia.

In various embodiments, the second monomer can comprise terephthalic acid, decanedioic acid, dodecanedioic acid, or mixtures thereof.

In one aspect, the circular natural gas is converted to methanol for producing an olefin. The olefin is combined with a butadiene to produce adiponitrile which is hydrogenated to form the first or second monomer. The butadiene can be formed from a circular carbon component comprising a circular oil or a circular naphtha.

In another aspect, the second monomer comprises a terephthalic acid (such as dimethyl terephthalic acid) and wherein the terephthalic acid is formed from a circular xylene through an oxidation reaction. The xylene can comprise p-xylene and can be formed from biomass. Alternatively, the p-xylene can be formed from recycled polyolefins.

In one aspect, the second monomer comprises terephthalic acid or dimethyl terephthalate derived from a recycled polymer, such as a recycled polyester.

In one aspect, the method can be used to produce a homopolymer, copolymer, or terpolymer of polyamide. Polyamides that can be produced include polyamide 4, polyamide 5, polyamide 6, polyamide 6.1, polyamide 7, polyamide 8, polyamide 8.1, polyamide 9, polyamide 9.1, polyamide 10, polyamide 10.1, polyamide 11, polyamide 12, polyamide 12.1, polyamide 46, polyamide 66, polyamide 666, polyamide 69, polyamide 96, polyamide 99, polyamide 610, polyamide 612, polyamide 910, polyamide 912, polyamide 1212, polyamide 6T, polyamide 7T, polyamide 8T, polyamide 9T, polyamide 10T, polyamide 12T, polyamide 1010, polyamide MXD6, polyamide IPDA.I, polyamide IPDA.T, polyamide MACM.I, polyamide MACM.T, polyamide PACM.I, and polyamide PACM.T, as well as copolyamides including polyamide 6T/8.7, polyamide 6T/9.7, polyamide 6T/10, polyamide 6T/10T, polyamide 6T/12, polyamide 6T/6I, polyamide 6T/6I. 9, polyamide 6T/6I. 10, polyamide 6T/6I. 12, polyamide 6T/6.9, polyamide 6T/6.12, polyamide 6T/DT, polyamide 6T/T, polyamide 6T/MACM.T, polyamide 6T/PACM.T, polyamide 6T/MXDA. T, polyamide 6T/610, polyamide 6T/66, polyamide 6T/6.1/8T/8.1, polyamide 8.7/6, polyamide 8.7/8.I, polyamide 8.7/66, polyamide 9T/910, polyamide 9T/912, polyamide 9T/11, polyamide 9T/12, polyamide 10T/6, polyamide 10T/11, polyamide 10T/12, polyamide 10T/66, polyamide 10T/46, polyamide 10T/1010, polyamide 10T/1012, polyamide 12T/6, polyamide 12T/66, polyamide 12T/1212, polyamide 4T/4.12, polyamide 4T/4.46, polyamide 5T/5I, polyamide 5T/51/5.6, polyamide 6/66, polyamide 6/10, polyamide 6/12, polyamide 6/612, polyamide 6T/6I/66, polyamide 6T/6I/6, polyamide 10T/101/6, polyamide 10T/101/6T, polyamide 6/66/10, polyamide 6/66/12, polyamide 6T/6I/10T/101, polyamide 6T/6I/IPDA. T/IPDA.I, polyamide 6T/61/MXDA. T/MXDA.I, polyamide 6T/6I/MACM. T/MACM.I, and the like.

The polyamide polymer formed through the method can be combined with various different components such as glass fibers. The glass fibers can be present in the polymer composition in an amount from about 5% by weight to about 65% by weight.

The polyamide polymer containing the circular atom content can be formed into a molded article. The molded article, for instance, can comprise an electrical connector or an automotive engine part.

Other features and aspects of the present invention are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a flow diagram of one embodiment of a process in accordance with the present disclosure for producing polyamide polymers;

FIG. 2 is a flow diagram of one embodiment of a method for producing a diamine monomer in accordance with the present disclosure;

FIG. 3 is another alternative embodiment of a flow diagram for producing a diamine monomer in accordance with the present disclosure;

FIG. 4 is a flow diagram illustrating one method for producing adiponitrile and/or a diacid in accordance with the present disclosure;

FIG. 5 is a flow diagram illustrating different methods for producing a terephthalic acid in accordance with the present disclosure;

FIG. 6 is a flow diagram illustrating a process for producing terephthalic acid or dimethyl terephthalic acid from recycled polyester materials in accordance with the present disclosure;

FIG. 7 is one embodiment of an electrical connector that can be made in accordance with the present disclosure;

FIG. 8 is another embodiment of an electrical connector that can be made in accordance with the present disclosure;

FIG. 9 is a flow diagram illustrating one method for producing adipic acid in accordance with the present disclosure;

FIG. 10 is a graphical representation of results obtained in the example below;

FIG. 11 is a graphical representation of results obtained in the example below; and

FIG. 12 is a graphical representation of results obtained in the example below.

FIG. 13 is a flow diagram of another embodiment of a method for producing a diamine monomer in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present invention.

As used herein, the term “about”, when used to modify an amount or value, refers to an approximation of an amount or value that is more or less than the precisely designated amount or value. The precise value of the approximation is determined by what one of skill in the art would recognize as appropriate. The use of the term “about” conveys the idea that similar values can bring about equivalent results or effects.

In the interests of brevity and conciseness, any ranges of values set forth in this disclosure contemplate all values within the range and are to be construed as support for claims reciting any sub-ranges having endpoints which are whole number values within the specified range in question. By way of hypothetical example, a disclosure of a range of from 1 to 5 shall be considered to support claims to any of the following ranges: 1 to 5; 1 to 4; 1 to 3; 1 to 2; 2 to 5; 2 to 4; 2 to 3; 3 to 5; 3 to 4; and 4 to 5.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40%” is intended to mean “about 40%.”

In general, the present disclosure is directed to producing polyamide polymers, such as high performance polyamide polymers, in a more sustainable manner. In accordance with the present disclosure, a circular carbon component is used directly or indirectly to produce intermediate components and/or monomers for producing the polyamide polymers. More particularly, in accordance with the present disclosure, one or more circular carbon components can be used in multiple processes for producing chemical components that are then combined to form a diamine monomer and/or a diacid monomer in producing the polyamide polymer.

For instance, the chemical synthesis of the monomers used to produce polyamides is somewhat complicated and involves many steps in producing precursor chemicals. In accordance with the present disclosure, a one or more circular carbon components can be used in producing many of the precursor chemicals that are used to produce the monomers. In one aspect, a single circular atom component, such as a circular carbon component, can also be used to produce both a diamine monomer and a diacid monomer. In this manner, the present disclosure is directed to an integrated process that uses circular atoms components in multiple pathways for producing polyamide polymers with a maximum value of circular atom content. Alternatively, a circular hydrocarbon can be used to produce the diamine and biomass or recycled polymers can be used to produce the diacid.

Polyamide polymers made in accordance with the present disclosure can fulfill the sustainability needs of many manufacturers and customers. The polyamide polymers can be used to produce all different types of products and articles in all different fields. The polyamide polymers, for instance, can be used to produce molded parts and articles for use in the medical field, automotive field, electrical field, the food handling industry, and the like. Manufacturers can incorporate the polyamide polymers into their products in order to meet goals for circular, renewable or bio-based content or for lower supply chain emissions. Overall, the polyamide polymers made according to the present disclosure can help manufacturers reduce usage of fossil feedstocks and lower their carbon emissions without in any way sacrificing quality or mechanical properties.

In one particular application, for instance, the polyamide polymers can be used in electric vehicles that do not run on fossilized fuels. The polyamide polymers, for instance, can be used to make electrical connectors, battery housings, and other components within the vehicle.

The amount of circular atoms, such as renewable atoms, (carbon and non-carbon) contained in the polyamide polymers of the present disclosure can be determined according to any suitable method. For instance, in one method, the polyamide polymers can be certified according to the International Sustainability and Carbon Certification (ISCC). The ISCC is a globally applicable sustainability certification system and covers various types of sustainable feedstocks, including agricultural and forestry biomass, circular and bio-based materials and renewables, and materials with reduced carbon footprint compared to industrial average. The ISCC can certify the mass balance approach in which the renewable content of the polymer can be verified. In mass balance, renewable feedstock is attributed to selected products, according to their individual chemistry and formulation taking into account all yields and losses. The key criteria used for applying the mass balance approach include feedstock qualification, chain of custody, and product claims.

The mass balance approach makes it possible to track the amount and sustainability characteristics of circular feedstocks, such as renewable feedstocks, in the value chain and attribute it to the final product in a verifiable manner. In one aspect, for instance, the polyamide polymers made according to the present disclosure can have a circular atom content (e.g. renewable, recycled, or the like) of at least about 10% by weight. For instance, the circular atom content of the polyamide polymers can be greater than about 14% by weight, such as greater than about 18% by weight, such as greater than about 22% by weight, such as greater than about 30% by weight, such as greater than about 35% by weight, such as greater than about 40% by weight, such as greater than about 45% by weight, such as greater than about 50% by weight, such as greater than about 55% by weight, such as greater than about 60% by weight, such as greater than about 65% by weight, such as greater than about 70% by weight, such as greater than about 75% by weight. The circular atom content of the polyamide polymers is generally less than about 99% by weight, such as less than about 90% by weight, such as less than about 80% by weight. Due to the complex manner in which polyamide monomers are formed, in the past, it was difficult to obtain a polyamide polymer, particularly high performance polyamide polymers, with any significant circular atom content. Through the processes of the present disclosure, however, much bigger amounts of circular atom content can be incorporated into the polymers in an integrated, efficient and elegant manner.

As described above, the chemical precursors that are used to produce the monomers for producing the polyamides are at least partially derived from a circular atom component. The circular atom component can vary depending upon the particular application. The circular atom component, for instance, can comprise a fluid, such as a biogas. A biogas, for instance, is a gas that is produced from biomass. Biogases are produced, for instance, from solid waste landfills and from anaerobic digestion plants, and the like. Alternatively, the circular atom component can comprise a recycled gas. The recycled gas, for instance, may be a gas obtained from an industrial process. Recycled gases, for instance, can be gases that are collected instead of being released to the atmosphere or generated and collected as a byproduct from advanced or chemical recycling processes. In other embodiments, the circular atom component can comprise biomass or plants or can comprise recycled polymers collected from the waste stream.

The circular atom component can comprise a gas as described above or a liquid, such as a hydrocarbon. In one aspect, the circular atom component comprises a circular natural gas. The natural gas, for instance, can be derived from biomass, such as vegetable by-products, animal by-products, cellulosic by-products, and the like. Alternatively, the natural gas can be a recycled gas from an industrial process or the like that would otherwise be released to the environment. In one embodiment, as will be described in greater detail below, the circular carbon component, such as circular natural gas, can be used in different processes to produce chemical precursors that are then used to produce the monomers for the polyamide polymers.

As described above, in one aspect, the circular carbon component used to produce the polyamide polymers can comprise a circular carbon gas, particularly a circular natural gas. Using a circular natural gas as a starting component to produce many of the chemical precursors in the process of the present disclosure can offer many advantages and benefits. For instance, circular gases, particularly circular natural gas, can contain little to no impurities which prevents impurities from showing up in the final product and interfering with the physical properties of the polymer. For example, in one aspect, the circular carbon component comprises a circular natural gas that contains methane in an amount greater than about 80% by weight, such as in an amount greater than about 85% by weight, such as in an amount greater than about 90% by weight, such as in an amount greater than about 93% by weight, such as in an amount greater than about 95% by weight, such as in an amount greater than about 97% by weight, such as even greater than about 99% by weight.

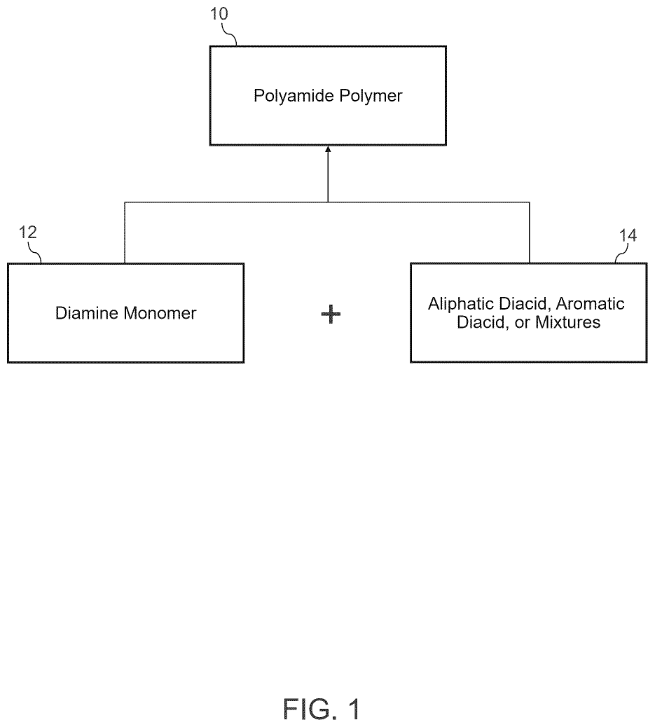

Referring to FIG. 1, one embodiment of a process for producing polyamide polymers in accordance with the present disclosure is shown. In one aspect, for instance, polyamide polymers according to the present disclosure are formed from a diamine monomer 12 in combination with a second monomer 14 comprising an aliphatic diacid, an aromatic diacid, or mixtures thereof. The second monomer 14, for instance, can comprise a terephthalic acid, isophthalic acid or derivative thereof, decanedioic acid, sebacic acid, dodecanedioic acid, or mixtures thereof. The flow diagram illustrated in FIG. 1, for instance, can be used to produce various different high performance polyamide polymers. For instance, polyamide polymers that can be produced in accordance with the present disclosure include polyamide 6T, polyamide 610, polyamide 612, copolymers thereof, and the like.

In accordance with the present disclosure, at least one of the monomers 12 and 14 or both of the monomers contain a circular atom component. In one aspect, the circular atom component can comprise circular methane.

Through the process and method of the present disclosure, polyamide polymers can be formed containing a significant amount of a circular atom component. Polyamides that may be made in accordance with the present disclosure include homopolymers and/or copolymers. The homopolymers and copolymers can be identified by their respective repeat units. For exemplary purposes only, the following list exemplifies the abbreviations used to identify monomers and repeat units in the polyamide polymers:

| Abbreviation | Description |
|---|---|
| HMD | hexamethylene diamine (or 6 when used in combination |
| | with a diacid) |
| T | Terephthalic acid |
| AA | Adipic acid |
| DMD | Decamethylenediamine |
| DDA | Decanedioic acid |
| DDDA | Dodecanedioic acid |
| I | Isophthalic acid |
| MXD | meta-xylylene diamine |
| 2-MPMD | 2-methylpentamethylenediamine |
| TMD | 1,4-tetramethylene diamine |
| 4T | polymer repeat unit formed from TMD and T |
| 6T | polymer repeat unit formed from HMD and T |
| DT | polymer repeat unit formed from 2-MPMD and T |
| MXD6 | polymer repeat unit formed from MXD and AA |
| 66 | polymer repeat unit formed from HMD and AA |
| 1010 | polymer repeat unit formed from DMD and DDA |
| 10T | polymer repeat unit formed from DMD and T |
| 410 | polymer repeat unit formed from TMD and DDA |
| 510 | polymer repeat unit formed from 1,5-pentanediamine and |
| | DDA |
| 610 | polymer repeat unit formed from HMD and DDA |
| 612 | polymer repeat unit formed from HMD and DDDA |
| 6 | polymer repeat unit formed from ϵ-caprolactam |
| 11 | polymer repeat unit formed from 11-aminoundecanoic acid |
| 12 | polymer repeat unit formed from 12-aminododecanoic acid |

Polyamide polymers that can be formed in accordance with the present disclosure include the homopolyamides polyamide 4, polyamide 5, polyamide 6, polyamide 6.1, polyamide 7, polyamide 8, polyamide 8.1, polyamide 9, polyamide 9.1, polyamide 10, polyamide 10.1, polyamide 11, polyamide 12, polyamide 12.1, polyamide 46, polyamide 66, polyamide 666, polyamide 69, polyamide 96, polyamide 99, polyamide 610, polyamide 612, polyamide 910, polyamide 912, polyamide 1212, polyamide 6T, polyamide 7T, polyamide 8T, polyamide 9T, polyamide 10T, polyamide 12T, polyamide 1010, polyamide MXD6, polyamide IPDA.I, polyamide IPDA. T, polyamide MACM.I, polyamide MACM.T, polyamide PACM.I, and polyamide PACM. T. Binary copolyamides suitable for the present disclosure include polyamide 6T/8.7, polyamide 6T/9.7, polyamide 6T/10, polyamide 6T/10T, polyamide 6T/12, polyamide 6T/6I, polyamide 6T/6I. 9, polyamide 6T/6I. 10, polyamide 6T/6I. 12, polyamide 6T/6.9, polyamide 6T/6.12, polyamide 6T/DT, polyamide 6T/T, polyamide 6T/MACM.T, polyamide 6T/PACM.T, polyamide 6T/MXDA. T, polyamide 6T/610, polyamide 6T/66, polyamide 8.7/6, polyamide 8.7/8.I, polyamide 8.7/66, polyamide 9T/910, polyamide 9T/912, polyamide 9T/11, polyamide 9T/12, polyamide 10T/6, polyamide 10T/11, polyamide 10T/12, polyamide 10T/66, polyamide 10T/46, polyamide 10T/1010, polyamide 10T/1012, polyamide 12T/6, polyamide 12T/66, polyamide 12T/1212, polyamide 4T/4.12, polyamide 4T/4.46, polyamide 5T/5I, polyamide 6/66, polyamide 6/10, polyamide 6/12, and polyamide 6/612. Ternary and higher-order polyamides suitable for the present disclosure include polyamide 5T/51/5.6, polyamide 6T/6I/66, polyamide 6T/6I/6, polyamide 10T/101/6, polyamide 10T/101/6T, polyamide 6/66/10, polyamide 6/66/12, polyamide 6T/6.1/8T/8.1, polyamide 6T/6I/10T/101, polyamide 6T/6I/IPDA. T/IPDA.I, polyamide 6T/6I/MXDA. T/MXDA.I, polyamide 6T/61/MACM.T/MACM.I, and the like.

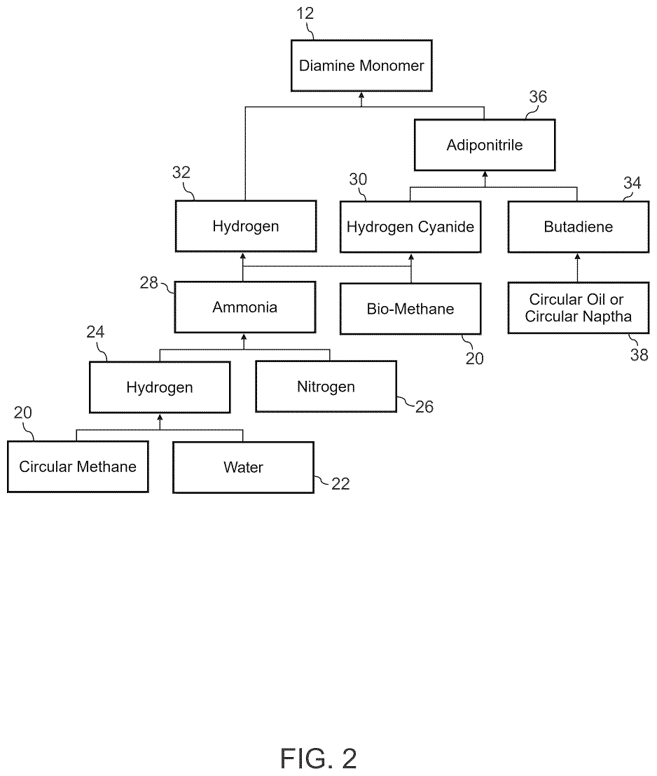

Referring to FIG. 2, a process diagram is provided representing one embodiment for producing the diamine monomer 12, which can comprise hexamethylene diamine. As shown, the process includes combining circular methane 20 in accordance with the present disclosure with water 22 to form hydrogen 24. In this manner, a circular hydrogen 24 is formed.

A common method for converting methane into hydrogen is steam methane reformation. In steam methane reformation, methane and steam are combined in the presence of a catalyst to produce hydrogen gas and carbon monoxide. The carbon monoxide may react with steam to produce more hydrogen, as is detailed in U.S. Pat. No. 3,361,534, which is incorporated by reference. The steam and methane for use in steam methane reformation may be kept at elevated temperatures in the reaction chamber, such as greater than 400 Fahrenheit, such as great than 500 Fahrenheit, such as greater than 600 Fahrenheit, such as greater than 700 Fahrenheit, such as greater than 800 Fahrenheit. Additionally, pressure may be increased about that of atmospheric pressure, such as greater than 5 atmospheres, such as greater than 10 atmospheres, such as greater than 15 atmospheres, such as greater than 20 atmospheres, such as greater than 25 atmospheres, such as greater than 30 atmospheres. Steam methane reformation may take place in the presence of a catalyst, such as a nickel catalyst. It should be understood, however, that the above process and process conditions are merely exemplary and do not in any way limit the process and product of the present disclosure.

As shown, the circular hydrogen 24 is then combined with nitrogen 26 to produce ammonia 28. In one aspect, the ammonia 28 can be produced according to an exothermic process.

A process for producing circular ammonia with hydrogen gas derived from circular methane may be the Haber-Bosch process. The Haber-Bosch process is a reaction which can proceed under high temperatures and pressures. Suitable temperatures may be greater than 750 degrees Fahrenheit, such as greater than 900 degrees Fahrenheit, such as greater than 1000 degrees Fahrenheit, such as greater than 1150 degrees Fahrenheit. Additionally, the process may proceed under pressures greater than 200 atmospheres, such as greater than 300 atmospheres, such as greater than 400 atmospheres. The process also may make use of catalysts, which include catalysts of osmium or iron, but may also include other metals such ruthenium. In addition to the presence of a catalyst, a promoter may be used, such as, but not limited to, molybdenum, potassium oxide or potassium hydroxide. In cases where a catalyst is used, high purity ammonia and circular methane are advantageous when they do not contain sulfur, phosphorus, arsenic or chlorine as impurities. It should be understood that the above process and process conditions are merely exemplary and do not in any way limit the process and product of the present disclosure.

Alternatively, the ammonia 28 can be produced using electrolysis. For instance, in one embodiment, the circular hydrogen 24 and the nitrogen 26 are introduced into an electrochemical cell. Within the cell, nitrogen gas undergoes a reduction reaction, facilitated by the electrical current and possibly a catalyst to produce ammonia.

The produced ammonia can be separated from the electrolyte and other by-products. Separation techniques can include, for instance, distillation or absorption. Any unreacted nitrogen or hydrogen gas can be recycled back to the electrochemical cell to improve efficiency and reduce waste. The exothermic process for producing ammonia may provide advantages over the Haber-Bosch process, such as the ability to operate at milder conditions and potentially lower energy requirements. The Haber-Bosch process, however, may be better suited for large scalability.

The ammonia produced according to the present disclosure can be blue ammonia, green ammonia, and/or turquoise ammonia.

As used herein, blue ammonia is ammonia produced using a process that significantly reduces carbon emissions compared to conventional methods. The production of blue ammonia involves producing hydrogen with reduced carbon emissions in comparison to conventional methods, combining it with nitrogen from the air, and synthesizing ammonia via the Haber-Bosch process. The process can incorporate carbon capture to ensure the process remains low-carbon, making blue ammonia an environmentally friendly alternative to traditional ammonia production methods.

In the first step, hydrogen is produced. For instance, Steam Methane Reforming (SMR) may be used. During SMR, circular natural gas (methane) is mixed with steam and heated to produce hydrogen (H2) and carbon monoxide (CO). This H2, CO, and CH4 stream from SMR can further be converted to a stream primarily containing H2, CO2, and N2 via autothermal reforming (ATR) by adding air and reacting over a catalyst. In other instances of blue hydrogen and ammonia production, ATR is the primary reaction used to produce a stream of H2, CO2, and N2. After removal of the CO2, the H2 and N2 stream can be used to synthesize ammonia. In the context of blue ammonia, the CO2 generated during this process is captured and stored or utilized, a method known as Carbon Capture and Storage (CCS) or Carbon Capture, Utilization, and Storage (CCUS). Most blue hydrogen and ammonia processes focus on capturing the CO2 from inside the reactors which is increased in concentration prior to being removed from the process. In one instance, blue hydrogen and ammonia can be produced from fossil natural gas. Capturing a portion of the CO2 from the process can reduce the carbon footprint of the products but not change the renewable content of the product. Alternatively, the renewable natural gas can be used to replace fossil natural gas to further reduce the carbon footprint of the products and provide renewable content to downstream products.

Alternatively, hydrogen can be produced using electrolysis, where water is split into hydrogen and oxygen using electricity. In one aspect, the electricity for electrolysis can come from renewable sources or low-carbon sources (such as wind, solar, or hydroelectric power), ensuring the process remains low-carbon. This process is generally referred to as green hydrogen as described below.

Alternatively, renewable hydrogen can be produced from renewable methane pyrolysis to produce hydrogen and carbon black. This renewable hydrogen can be utilized to produce renewable ammonia with lower carbon emissions in comparison to traditional ammonia production methods. This process produces turquoise hydrogen and turquoise ammonia.

The process also involves obtaining a nitrogen source. Nitrogen (N2) is typically obtained from the air through a process called air separation, where atmospheric air is cooled and distilled to separate nitrogen from other components like oxygen and argon.

The hydrogen and nitrogen are then combined using the Haber-Bosch process to produce the blue ammonia. This involves reacting the gases at high temperature and pressure in the presence of a catalyst to produce ammonia (NH3).

As used herein, green ammonia is produced using renewable energy sources, resulting in minimal carbon emissions throughout the production process. More particularly, green ammonia is produced by electrolyzing water to produce hydrogen using renewable electricity, obtaining nitrogen from the air, and synthesizing ammonia via the Haber-Bosch process, all powered by renewable energy. The reliance on renewable energy throughout the production process ensures that green ammonia has a minimal carbon footprint, making it a sustainable alternative to conventionally produced ammonia.

For instance, hydrogen is first produced through electrolysis from water. Water (H2O) is split into hydrogen (H2) and oxygen (O2) using electricity in an electrolyzer. For green ammonia, the electricity used in this process can come from renewable sources such as wind, solar, hydroelectric power, or by using the circular methane as a fuel source.

Nitrogen is also produced in a sustainable way using air separation. Nitrogen (N2) is separated from atmospheric air. This is typically done through cryogenic distillation, where air is cooled to very low temperatures and then distilled to separate nitrogen from other components like oxygen and argon. The energy required for this process can also come from renewable sources to maintain the green ammonia production criteria.

The Haber-Bosch process is then used to produce the green ammonia. The hydrogen and nitrogen gases are fed into the Haber-Bosch reactor. Under high temperature and pressure, and in the presence of a catalyst, the gases react to form ammonia (NH3). The energy required for this process can again come from renewable sources to ensure the production chain keeps carbon emissions low.

As shown in FIG. 2, the circular ammonia 28 that is produced is then combined with further amounts of the circular methane 20 for producing hydrogen cyanide 30 and possibly more hydrogen 32.

A process for producing hydrogen cyanide may comprise the Andrussow process. In the Andrussow process, ammonia, methane, and oxygen are reacted over a catalyst to form at least HCN. The catalyst may comprise platinum and/or rhodium. Additionally, the Andrussow process is conducted at temperatures higher than room temperature, such as greater than 1800 degrees Fahrenheit, such as greater than 1900 degrees Fahrenheit such as greater than 2000 degrees Fahrenheit, such as greater than 2100 degrees Fahrenheit. The pressure of the reaction may be atmospheric pressure or near atmospheric pressure, such as less than 1 atm, or greater than 1 atm. Pressures greater than atmospheric pressure may be greater than 2 atmospheres, or greater than 3 atmospheres. Additionally, pressures may be less than 3 atmospheres, such as less than 2 atmospheres, such as less than 1 atmosphere, such as less than 0.75 atmospheres. While the reaction chamber may not be particularly limited, one preferred reaction chamber may be a series of tubes. The series of tubes may comprise a bed of catalysts, such as platinum or rhodium. The reaction chamber may be a general reactor. It should be understood, however, that the above process and process conditions are merely exemplary and do not in any way limit the process and product of the present disclosure.

Another way of producing hydrogen cyanide may be the Degussa process, or BMA process. The BMA process also uses methane and ammonia. The BMA process may be conducted at elevated temperatures, such as greater than 1900 degrees Fahrenheit such as greater than 2000 degrees Fahrenheit, such as greater than 2100 degrees Fahrenheit, such as greater than 2200 degrees Fahrenheit. Additionally, the process may take place in the presence of a bed of catalysts, said catalyst comprising platinum. While the reaction chamber for the BMA process may be a general reactor, a particular reactor that may be used is a pipe with platinum catalyst coated inside. In the embodiment wherein the reaction chamber is a pipe, ammonia and methane are passed through the pipe. The ammonia and methane may be at, above, or below atmospheric pressure, such as greater than 1 atmosphere, such as greater than 2 atmospheres, or greater than 3 atmospheres. Additionally, pressures may be less than 3 atmospheres, such as less than 2 atmospheres, such as less than 1 atmosphere, such as less than 0.75 atmospheres. It should be understood, however, that the above process and process conditions are merely exemplary and do not in any way limit the process and product of the present disclosure.

Whether using the Andrussow process or the BMA process, the hydrogen cyanide 30 produced according to the present disclosure contains significant amounts of circular atoms including circular carbon. For instance, in one embodiment, all of the carbon contained in the hydrogen cyanide 30 can comprise circular carbon.

As shown, the hydrogen cyanide 30, in one embodiment, is combined with butadiene 34 for producing adiponitrile 36.

Adiponitrile may be made by the hydrocyanation of 1,3-butadiene. In such a reaction, hydrogen cyanide is reacted with 1,3-butadiene to first form 3-pentenenitrile. As a side product of this reaction, 2-methyl-3-butenenitrile is produced. 2-methyl-2-butenenitrile is isomerized to 3-pentenenitrile. Finally, 3-pentenenitrile undergoes hydrocyanation to form adiponitrile. This process may be carried out at, above, or below atmospheric pressure, such as greater than 1 atmosphere, such as greater than 2 atmospheres, or greater than 3 atmospheres. Additionally, pressures may be less than 3 atmospheres, such as less than 2 atmospheres, such as less than 1 atmosphere, such as less than 0.75 atmospheres. This process may be carried out in the presence of catalysts. Additionally, elevated temperatures may be used, such as greater than 300 degrees Fahrenheit, such as greater than 400 degrees Fahrenheit, such as greater than 500 degrees Fahrenheit, such as greater than 600 degrees Fahrenheit, such as greater than 700 degrees Fahrenheit. It should be understood, however, that the above process and process conditions are merely exemplary and do not in any way limit the process and product of the present disclosure.

In one aspect, the butadiene 34 used to produce the adiponitrile 36 can also have a circular atom content. For instance, the butadiene 34 can be produced from a circular naphtha or a circular pyrolysis oil 38 as shown in FIG. 2.

For instance, in one aspect, the butadiene 34 is produced from circular naphtha. The circular naphtha can be produced from biomass sources like vegetable oils, animal fats, crude tall oil or the like. The circular naphtha is then subjected to steam cracking. In this process, the circular naphtha is heated to high temperatures such as from about 850° C. to about 900° C. in the presence of steam. This causes the larger hydrocarbon molecules to break down into smaller ones. The product of steam cracking contains a mixture of various hydrocarbons, including butadiene 34. Butadiene can be separated from the resulting mixture through a series of purification steps, typically involving distillation and sometimes other methods such as extraction or adsorption.

The separated butadiene can undergo further purification to remove any remaining impurities ensuring high purity of the final product. In this manner, the butadiene 34 can contain a significant portion of circular atom content. In one aspect, for instance, 100% of the carbon contained in the butadiene can comprise circular carbon.

Alternatively as shown in FIG. 2, the butadiene 34 can be produced from a circular oil. The circular oil can be a cooking oil or a pyrolysis oil.

In one aspect, for instance, biomass, such as wood, agricultural residues, or algae is subjected to pyrolysis. Pyrolysis involves heating the biomass in the absence of oxygen to break it down into smaller molecules. This process typically occurs at temperatures ranging from about 400° C. to about 700° C.

The vapors produced during biomass pyrolysis are cooled causing them to condense into a liquid mixture known as pyrolysis oil. This oil contains a wide range of organic compounds, including butadiene precursors.

The pyrolysis oil is then subjected to separation and upgrading processes to isolate the desired compounds, including butadiene. Fractionation techniques, such as distillation or solvent extraction, may be employed to separate the butadiene from the other components in the pyrolysis oil. Depending upon the composition of the pyrolysis oil, additional steps such as hydrogenation or dehydration may be used to convert certain compounds into butadiene. Hydrogenation can saturate double bonds in the molecules, while dehydration can remove water molecules to promote the formation of butadiene.

The butadiene fraction obtained from the above process can undergo further purification to remove any remaining impurities and contaminants.

During production of butadiene using any of the above processes, any other hydrocarbons produced during the process, such as C4 or C5 hydrocarbons can be used as an energy source in producing the butadiene or for use anywhere else in the process.

As shown in FIG. 2, the adiponitrile produced from the hydrogen cyanide 30 and the butadiene 34 can be combined with circular hydrogen to produce the diamine monomer 12.

For instance, adiponitrile may be hydrogenated to form a diamine monomer. The diamine monomer may comprise hexamethylenediamine though one having ordinary skill in the art may recognize that adiponitrile can be used to produce a much larger array of diamines.

The process of hydrogenating adiponitrile into hexamethylenediamine may comprise reacting adiponitrile with hydrogen gas. The hydrogen gas used in hydrogenation of adiponitrile may be a circular hydrogen gas, produced by the above steam reformation process. This process is typically carried out at elevated temperatures, such as greater than 500 degrees Fahrenheit, such as greater than 600 degrees Fahrenheit, such as greater than 700 degrees Fahrenheit, such as greater than 800 degrees Fahrenheit, such as greater than 900 degrees Fahrenheit, such as greater than 1000 degrees Fahrenheit, such as greater than 1100 degrees Fahrenheit. Additionally, pressure may be increased about that of atmospheric pressure, such as greater than 5 atmospheres, such as greater than 10 atmospheres, such as greater than 15 atmospheres, such as greater than 20 atmospheres, such as greater than 25 atmospheres, such as greater than 30 atmospheres. A catalyst may be used in the process of hydrogenation, such as iron, nickel, or rhodium. It should be understood, however, that the above process and process conditions are merely exemplary and do not in any way limit the process and product of the present disclosure.

Alternatively, the Andrussow process described above and the BMA process described above can produce hydrogen gas as a byproduct in formation of hydrogen cyanide. The hydrogen gas can contain renewable content from the use of circular natural gas into the process and circular ammonia into the process. The renewable hydrogen gas byproduct can be captured as shown in FIG. 1. A process for capturing hydrogen, for instance, is described in WO2014099607A1, “Integrated process for hexamethylenediamine production” which is incorporated herein by reference. Capturing and utilizing the renewable hydrogen byproduct from the Andrussow or BMA process with circular natural gas or circular ammonia feedstock can add circular content of up to 7% by weight in hexamethylenediamine and add circular content of up to 3% by weight in the polyamide polymers. (Stoichiometry shows hydrogen generated as byproduct is 50% excess to what is needed to hydrogenate adiponitrile.)

The diamine monomer 12 made in accordance with the present disclosure can contain a significant amount of circular atoms, including carbon and non-carbon atoms. For instance, the diamine monomer 12 can contain circular atoms in an amount greater than about 30% by weight, such as in an amount greater than about 40% by weight, such as in an amount greater than about 45% by weight, such as in an amount greater than about 55% by weight, such as in an amount greater than about 65% by weight, such as in an amount greater than about 75% by weight, such as in an amount greater than about 80% by weight, such as in an amount greater than about 85% by weight, such as in an amount greater than about 90% by weight. The circular atom content of the diamine monomer 12, for instance, can, in various embodiments, be between about 47% by weight and about 99% by weight, such as between about 47% by weight and about 93% by weight.

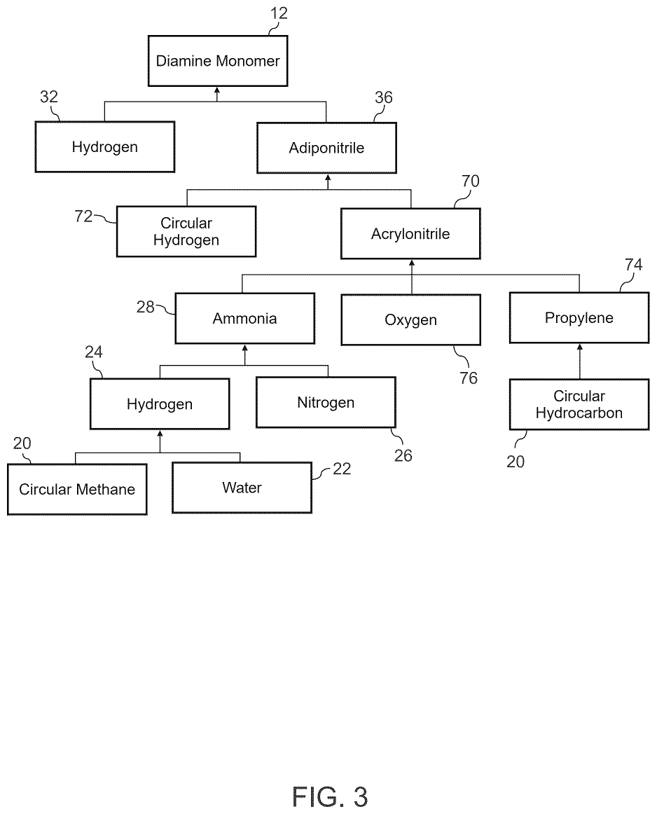

Referring to FIG. 3, an alternative embodiment for producing the diamine monomer 12 is shown. Like reference numerals have been used to indicate similar elements. In the embodiment in FIG. 3, similar to the embodiment in FIG. 2, circular methane 20 is steam reformed with water 22 to form hydrogen 24. The hydrogen 24 is combined with nitrogen 26 to produce ammonia 28.

In the embodiment illustrated in FIG. 3, however, acrylonitrile 70 is produced containing circular carbon that is then combined with hydrogen 72 for producing the adiponitrile 36.

In order to form the acrylonitrile 70, the circular methane 20 is first used to produce propylene 74. To produce propylene (propene, C3H6) from methane (CH₄), a series of chemical processes can be employed. For instance, in one embodiment, the first step is to convert methane into a synthesis gas (syngas), a mixture of hydrogen (H₂) and carbon monoxide (CO). This can be done through steam methane reforming (SMR):

CH4+H2O→CO+3H2

The syngas can then be converted into methanol (CH3 OH) via a catalytic process:

CO+2H2→CH3OH

The methanol can be converted into light olefins such as ethylene (C2H4) and propylene through a Methanol-to-Olefins (MTO) process. MTO processes are disclosed in U.S. Pat. Nos. 10,011,541 and 11,001,542, which are incorporated herein by reference. Any other hydrocarbons produced during the process, such as C4 or C5 hydrocarbons can be used as an energy source for increasing the efficiency in producing propylene. The process can include dehydration and cracking reactions:

2CH3OH→C2H4+2H2O

and

3CH3OH→C3H6+3H2O

Alternatively, there is a specific Methanol-to-Propylene (MTP) process developed to maximize the yield of propylene.

In another embodiment, Oxidative Coupling of Methane (OCM) can be used to directly convert methane into ethylene, which can then be oligomerized and cracked to produce propylene. The process involves the oxidative coupling of methane molecules, typically using oxygen (O₂) as the oxidizing agent. The process requires catalysts to facilitate the reaction. Common catalysts include metal oxides such as those of lithium, magnesium, and lanthanum. These catalysts help lower the activation energy required for the reaction and improve selectivity toward the desired products. The basic mechanism involves the activation of methane and oxygen on the catalyst surface, forming methyl radicals (CH₃•) and other reactive intermediates. These intermediates then couple to form C₂ hydrocarbons. The initial step can be represented as follows:

2CH4+O2→C2H4+2H2O

The ethylene can then be converted into propylene via processes like the olefin metathesis reaction:

C2H4+C4H8→2C3H6

In still another embodiment, methane pyrolysis can be used to form propylene. Methane can be directly decomposed into hydrogen and acetylene at high temperatures. The acetylene can then be converted to ethylene and further to propylene.

Still another route involves converting syngas directly to hydrocarbons via the Fischer-Tropsch process, producing a range of hydrocarbons that can be further refined and cracked to obtain propylene.

The propylene 74 containing circular carbon is then combined with oxygen 76 and the ammonia 28 formed from the circular acrylonitrile 70.

For example, in one aspect, the acrylonitrile 70 can be produced from the ammonia 28, oxygen 76, and propylene 74 in a process known as the SOHIO process. During this process, the ammonia, propylene, and oxygen are combined in a single reactor to convert to acrylonitrile 70 and hydrogen cyanide. This reaction can take place in the presence of a catalyst in a fluidized bed. The acrylonitrile 70 contains circular carbon and/or other circular atoms.

As shown in FIG. 3, the acrylonitrile 70 is then combined with hydrogen 72 to form the adiponitrile 36. The hydrogen 72, for instance, can be obtained from the circular methane 20 through a steam reforming process. The production of adiponitrile from acrylonitrile and hydrogen involves a catalytic hydrogenation reaction. The reaction occurs in the presence of a catalyst, such as a nickel-based catalyst. The acrylonitrile 70 is converted to the adiponitrile 36 during the process. The adiponitrile 36 can then be combined with further amounts of hydrogen 32 for producing the diamine monomer 12.

In the reaction scheme illustrated in FIG. 3, the diamine monomer 12 can contain circular atoms, particularly circular oxygen atoms, in an amount greater than about 20% by weight, such as in an amount greater than about 25% by weight, such as in an amount greater than about 30% by weight, such as in an amount greater than about 35% by weight, such as in an amount greater than about 40% by weight, such as in an amount greater than about 45% by weight, such as in an amount greater than about 50% by weight, and in an amount less than about 90% by weight, such as in an amount less than about 85% by weight, such as in an amount less than about 80% by weight. For instance, in one aspect, the diamine monomer 12 can contain circular atoms in an amount from about 10% by weight to about 98% by weight, such as from about 20% by weight to about 95% by weight, such as from about 29% by weight to about 72% by weight depending upon recurrent use of the circular methane 20.

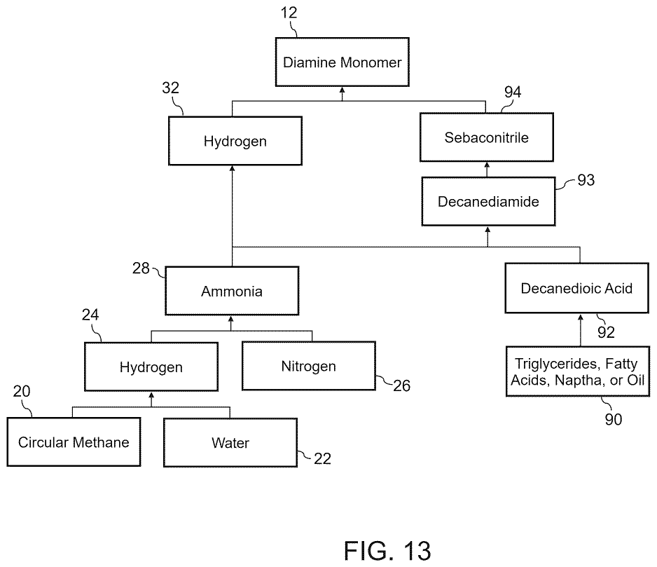

Referring to FIG. 13, another alternative embodiment for producing the diamine monomer 12 is shown. Like reference numerals have been used to indicate similar elements. In the embodiment in FIG. 13, decanedioic acid 92 is combined with ammonia 28 to form decanediamide 93. Decanediamide 93 is then dehydrogenated to produce sebaconitrile 94, which can subsequently be used to form the diamine monomer 12, particularly decamethylene diamine.

Sebaconitrile 94 may be prepared by dehydrogenation of decanediamide 93. In this reaction, decanediamide 93 is contacted with suitable dehydrogenation agents to produce intermediates that ultimately yield sebaconitrile 94. The process may be carried out at, above, or below atmospheric pressure, such as greater than 1, 2, or 3 atmospheres or less than 3, 2, or 1 atmosphere. Catalysts may be used. Elevated temperatures such as greater than 300, 400, 500, 600, or 700 degrees Fahrenheit may be employed. These conditions are exemplary only.

In one aspect, the decanedioic acid 92 used to produce decanediamide 93 and subsequently sebaconitrile 94 can have a circular atom content. For instance, decanedioic acid 92 can be produced from circular carbon sources by utilizing renewable lipid-based feedstocks. Renewable triglycerides or fatty acids 90 derived from materials such as vegetable oils, waste cooking oils, tall oil, or algal oils can serve as substrates containing C12 hydrocarbon chains. These substrates can be subjected to a biological oxidation process in which microorganisms convert the C12 fatty components, including lauric-acid-containing fractions, into the corresponding dicarboxylic acid. The resulting oxidation product is then processed through conventional purification steps to yield a high-purity, circular atom form of decanedioic acid 92 suitable for downstream chemical applications.

Alternatively, decanedioic acid 92 can also be produced from a circular naphtha or a circular pyrolysis oil 90 as shown in FIG. 13. In one aspect, the circular naphtha may be produced from biomass sources such as vegetable oils, animal fats, crude tall oil, or similar bio-derived feedstocks. The circular naphtha may be subjected to a cracking or conversion operation at elevated temperatures in the presence of steam or other suitable agents. This conversion can produce a mixture of hydrocarbons that includes precursors suitable for forming decanedioic acid 92.

The mixture obtained from the conversion of circular naphtha may undergo purification steps including, for example, distillation or extraction. These steps may separate components that serve as decanedioic acid 92 precursors. Additional upgrading may be used to prepare decanedioic acid 92 with high purity and high circular atom content.

Alternatively, and as shown in FIG. 13, decanedioic acid 92 can be produced from a circular oil 90. The circular oil 90 may include cooking oil, pyrolysis oil, or other circular hydrocarbon streams.

In one aspect, biomass such as wood, agricultural residues, or algae may be subjected to pyrolysis at elevated temperatures in the absence of oxygen, producing vapors that condense into pyrolysis oil. The pyrolysis oil may include components useful for forming decanedioic acid 92.

These condensed vapors may be fractionated to isolate desirable components and remove unwanted fractions. Conversion steps such as hydrogenation, dehydration, or other upgrading processes may be used to prepare decanedioic acid 92 intermediates from the circular oil. The decanedioic acid 92 fraction may undergo further purification steps to achieve a desired purity and remove contaminants or impurities.

Additional hydrocarbons produced during the conversion of circular feedstocks may be used as an energy source within the process or for other integrated process needs.

As shown in FIG. 13, the sebaconitrile 94 produced from decanediamide 93 can be hydrogenated to produce the diamine monomer 12. For instance, sebaconitrile 94 may be hydrogenated to form a diamine monomer 12. The diamine monomer 12 may comprise decamethylene diamine, though one having ordinary skill in the art will recognize that sebaconitrile 94 can be used to produce a broader range of diamines.

The process of hydrogenating sebaconitrile 94 into decamethylene diamine may comprise reacting sebaconitrile 94 with hydrogen gas. Hydrogenation may be conducted at elevated temperatures such as greater than 500, 600, 700, 800, 900, 1000, or 1100 degrees Fahrenheit and at elevated pressures such as greater than 5, 10, 15, 20, 25, or 30 atmospheres. Catalysts may include iron-, nickel-, or rhodium-based materials. These conditions are exemplary and not limiting.

The diamine monomer 12 produced in FIG. 13 according to the present disclosure can contain significant circular atom content. For instance, the diamine monomer 12 can contain circular atoms in an amount greater than 30%, 40%, 45%, 55%, 65%, 75%, 80%, 85%, or 90% by weight. In various embodiments, the circular atom content of the diamine monomer 12 can range from about 47% to about 99% by weight, such as from about 47% to about 93% by weight.

As shown in FIG. 1, in order to produce polyamide polymers in accordance with the present disclosure, the diamine monomer 12 is reacted with at least one second monomer 14. In one aspect, the second monomer can comprise an aliphatic diacid containing 4 to 20 carbon atoms, an aromatic diacid containing 8 to 20 carbon atoms, or mixtures thereof. In accordance with the present disclosure, the second monomer can also be made from a circular carbon component.

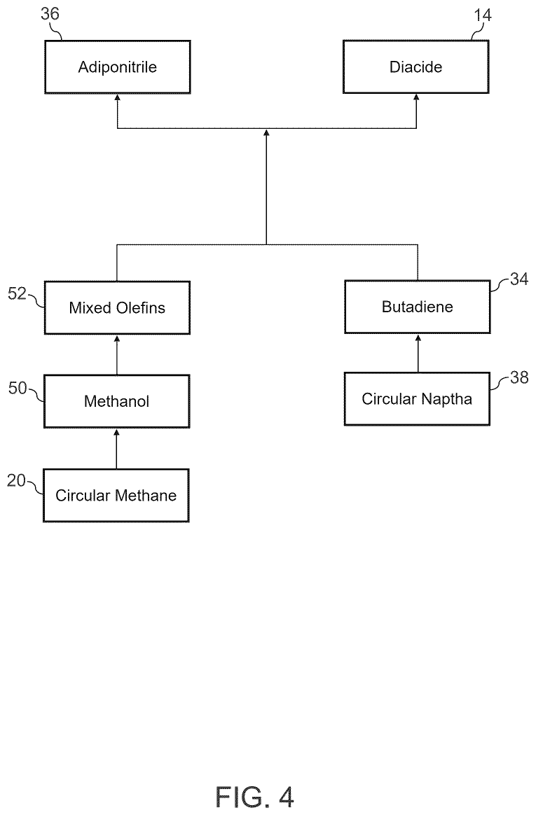

For example, referring to FIG. 4, one embodiment of a process for producing the diacid 14 is illustrated. As shown in FIG. 4, the circular methane 20 is first converted to methanol 50. Converting circular methane 20 to circular methanol 50 can occur using various different processes. In one aspect, for instance, methane 20 can be converted to methanol 50 through methane oxidation. In this process, methane is partially oxidized in the presence of a catalyst. Various different catalysts and reaction conditions can be used. The catalyst, for instance, can be a copper-exchanged zeolite, an iron-based catalyst, or a platinum-based catalyst. During the process, methane reacts with oxygen or peroxide to form methanol.

Alternatively, the methanol 50 can be produced from the methane 20 in a two-step process. For instance, the methane 20 can first be converted to a syngas via steam reforming. The syngas is then converted to methanol using a catalyst, like a copper-zinc oxide-aluminum oxide catalyst.

As shown in FIG. 4, the methanol 50 containing circular carbon atoms is then converted into mixed olefins 52. For instance, methanol 50 can be converted to mixed olefins 52 using a process known as Methanol-to-Olefins (MTO). During the process, methanol is subjected to temperatures and pressures that lead to the formation of dimethyl ether. The dimethyl ether is then further broken down into a mixture of light olefins using a catalyst. The catalyst, for instance, can be a zeolite-based catalyst. Such catalysts include ZSM-5 or SAPO-34.

As illustrated in FIG. 4, the mixed olefins 52 can then be combined with butadiene 34 in order to produce the diacid 14. The butadiene 34 can also have a circular atom content as described above by being formed from circular naphtha 38 or from a circular oil.

In order to produce the diacid 14, the mixed olefins 52 and the butadiene 34 can undergo a Diels-Alder reaction followed by oxidation. During the Diels-Alder reaction, the butadiene is reacted with an alkene to form a cyclohexene derivative. Oxidative cleavage is then used to convert the cyclohexene derivative into a diacid. This can be achieved using oxidative reagents such as potassium permanganate or ozone.

Through this process, various different diacids can be formed, such as dodecanedioic acid.

As shown in FIG. 4, the flow sequence can also be used to produce adiponitrile 36. The adiponitrile can be hydrogenated to form the first or second monomer.

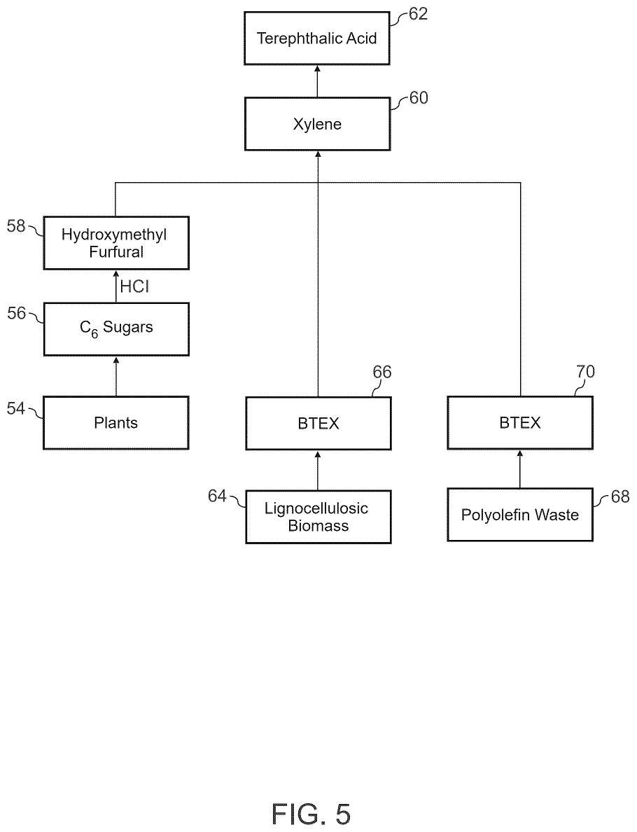

In addition to aliphatic diacids, polyamide polymers made according to the present disclosure can also be formed from aromatic diacids. For instance, as shown in FIG. 5, three different process sequences are shown in order to form a circular terephthalic acid.

Referring to FIG. 5, for instance, in one embodiment, plant material 54 is first converted into C6 sugars 56. The C6 sugars are then converted into a hydroxymethyl furfural or other cyclohexadiene intermediate through the use of an acid catalyst, such as hydrochloric acid.

The hydroxymethyl furfural 58 or other cyclohexadiene intermediate is then dehydrogenated to produce xylene 60, such as p-xylene.

The p-xylene 60 can then be converted to terephthalic acid 62 and used as a monomer for producing the polyamide polymers. Through the process as described above, a bio-based xylene 60 is produced that is then used to produce a bio-based terephthalic acid 62. The bio-based terephthalic acid 62 is virtually formed entirely from circular atoms.

In order to form the terephthalic acid 62, for instance, the p-xylene 60 can be oxidized typically in air and in the presence of a catalyst. The catalyst, for instance, can comprise a cobalt-manganese catalyst.

As shown in FIG. 5, two alternative methods or processes for producing bio-based xylene 60 are shown. In one aspect, for instance, lignocellulosic biomass 64 can be converted to BTEX, which refers to a mixture of benzene, toluene, ethyl benzene, and xylene. For instance, the lignocellulosic biomass 64 can first be pretreated in order to break down the polymers into smaller, more reactive components. In one aspect, acid hydrolysis using acids like sulfuric acid or hydrochloric acid can be used to break down hemicellulose and/or cellulose into the sugar monomers. Lignin can also be partially degraded into phenolic compounds.

The sugars produced from cellulose and hemicellulose can then be converted into various intermediates, such as furans, levulinic acid, and lactic acid. The sugars can be converted into the intermediates using, for instance, acid catalysts in a dehydration process. To produce BTEX, the intermediate chemicals, such as HMS and furfural undergo catalytic conversion using zeolite-catalyzed reactions. After the catalytic conversion process, the reaction products are separated and purified using distillation in order to collect p-xylene.

As shown in FIG. 5, alternatively, the BTEX can be produced from polyolefin waste, such as polyolefin materials collected from the recycle stream. For instance, polyolefin waste which may include polyethylene polymers and/or polypropylene polymers can be fed through a pyrolysis or catalytic cracking process and broken down into smaller molecules including BTEX 70. The BTEX 70 can then be used to collect p-xylene 60 for producing a terephthalic acid 62.

In still another embodiment of the present disclosure, a terephthalic acid can be produced from polyester waste materials, such as recycled polyester polymers. The polyester waste materials, for instance, can comprise polyethylene terephthalate polymers.

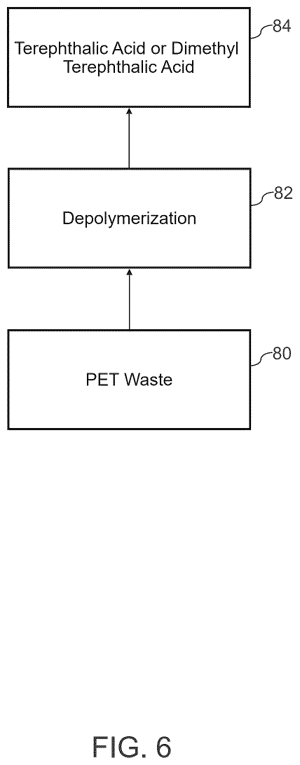

As shown in FIG. 6, for instance, the polyethylene terephthalate waste 80 can be fed through a depolymerization process 82 for producing terephthalic acid or dimethyl terephthalic acid 84.

For instance, the recycled or waste PET 80 can be fed through a hydrolysis process in which the PET is hydrolyzed in the presence of water, usually under acidic, alkaline, or neutral conditions. The process converts PET back into terephthalic acid and ethylene glycol. In an alternative embodiment, the PET waste 80 can be fed through a glycolysis process. During this process, the PET waste undergoes glycolysis with ethylene glycol to form 2-hydroxyethyl terephthalate which can be further converted into terephthalic acid or dimethyl terephthalic acid. The resulting terephthalic acid 84 can be purified and used as a monomer in producing the polyamide polymers of the present disclosure.

The processes as describe above to make terephthalic acid can also be used to product isothalic acid. For example, isothalic acid can be produced from xylene through an oxidation process. The isothalic acid can then be used to produce copolymers such as polyamide 6T/6I.

Through the processes as shown in FIGS. 1-6, various different high performance polyamide polymers can be produced from the monomers that contain a significant amount of circular atoms. Polyamide polymers that can be produced include polyamide 4, polyamide 5, polyamide 6, polyamide 6.1, polyamide 7, polyamide 8, polyamide 8.1, polyamide 9, polyamide 9.1, polyamide 10, polyamide 10.1, polyamide 11, polyamide 12, polyamide 12.1, polyamide 46, polyamide 66, polyamide 666, polyamide 69, polyamide 96, polyamide 99, polyamide 610, polyamide 612, polyamide 910, polyamide 912, polyamide 1212, polyamide 6T, polyamide 7T, polyamide 8T, polyamide 9T, polyamide 10T, polyamide 12T, polyamide 1010, polyamide MXD6, polyamide IPDA.I, polyamide IPDA.T, polyamide MACM.I, polyamide MACM.T, polyamide PACM.I, and polyamide PACM.T, as well as copolyamides including polyamide 6T/8.7, polyamide 6T/9.7, polyamide 6T/10, polyamide 6T/10T, polyamide 6T/12, polyamide 6T/6I, polyamide 6T/6I. 9, polyamide 6T/6I. 10, polyamide 6T/6I. 12, polyamide 6T/6.9, polyamide 6T/6.12, polyamide 6T/DT, polyamide 6T/T, polyamide 6T/MACM.T, polyamide 6T/PACM.T, polyamide 6T/MXDA.T, polyamide 6T/610, polyamide 6T/66, polyamide 6T/6.1/8T/8.1, polyamide 8.7/6, polyamide 8.7/8.1, polyamide 8.7/66, polyamide 9T/910, polyamide 9T/912, polyamide 9T/11, polyamide 9T/12, polyamide 10T/6, polyamide 10T/11, polyamide 10T/12, polyamide 10T/66, polyamide 10T/46, polyamide 10T/1010, polyamide 10T/1012, polyamide 12T/6, polyamide 12T/66, polyamide 12T/1212, polyamide 4T/4.12, polyamide 4T/4.46, polyamide 5T/5I, polyamide 5T/51/5.6, polyamide 6/66, polyamide 6/10, polyamide 6/12, polyamide 6/612, polyamide 6T/6I/66, polyamide 6T/6I/6, polyamide 10T/101/6, polyamide 10T/101/6T, polyamide 6/66/10, polyamide 6/66/12, polyamide 6T/6I/10T/101, polyamide 6T/6I/IPDA. T/IPDA.I, polyamide 6T/6I/MXDA. T/MXDA.I, polyamide 6T/61/MACM. T/MACM.I, and the like.

Particular polymers that can be produced include, for instance, polyamide 6T, polyamide 610, polyamide 612, polyamide 1010, polyamide 10T, and copolymers thereof.

Particular copolymers that can be produced include polyamide 6T/66, polyamide 6T/6I, polyamide 6I/6T, polyamide 6T/DT, polyamide 6T/6I/66, polyamide 6/66/10, polyamide 6T/6I/6, polyamide 6/66/12, or the like.

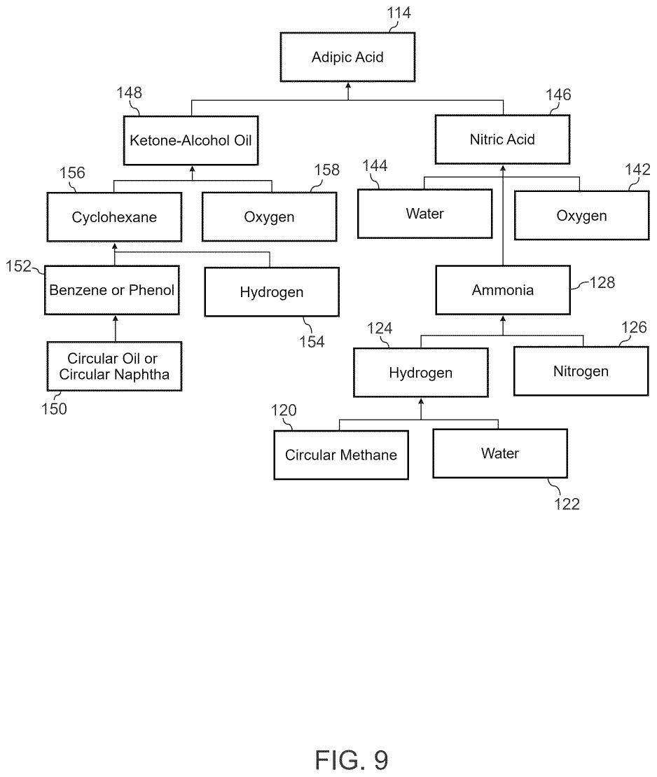

When producing polyamide 6T/66, for example, the polyamide 66 can be formed from the diamine monomer described above reacted with adipic acid. Referring to FIG. 9, a process pathway is illustrated showing one embodiment for producing adipic acid 14 from the circular atom component of the present disclosure.

As shown, circular methane 120 is steam reformed using water 122 to produce hydrogen 124 as described above. The hydrogen 124 is combined with nitrogen 126 to produce ammonia 128 as described above, which may be blue ammonia, green ammonia, or turquois ammonia. The circular ammonia 128 is then combined with oxygen 142 and water 144 to produce nitric acid 146. The oxygen 142, water 144, and circular ammonia 128 are combined together at high temperature in the presence of a catalyst to produce the nitric acid 146.

A common reaction scheme follows:

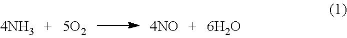

Commonly, this reaction is carried at temperatures greater than 1000 degrees Fahrenheit, such as greater than 1200 degrees Fahrenheit, such as greater than 1400 degrees Fahrenheit, such as greater than 1600 degrees Fahrenheit. Additionally, this reaction is often run in the presence of a rhodium and platinum gauze catalyst. The nitric oxide is then reacted as shown below:

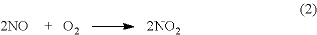

Lastly, nitrogen dioxide is reacted with water according to the reaction below:

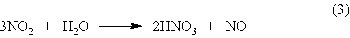

Typically, the first reaction is carried out at low pressures, whereas the second and third reactions are carried out at high pressures. Low pressures for the first reaction can be lower than 10 atmospheres, such as lower than 5 atmospheres, such as lower than 1 atmosphere, such as lower than 0.5 atmospheres. High pressures for the second and third reaction can be higher than 1 atmosphere, such as higher than 5 atmospheres, such as higher than 10 atmospheres, such as higher than 15 atmospheres, such as higher than 20 atmospheres. This nitric acid is often then distilled by extractive distillation using sulfuric acid and a dehydrating agent. It should be understood, however, that the above process and process conditions are merely exemplary and do not in any way limit the process and product of the present disclosure.

As shown in FIG. 9, nitric acid 146 is combined with ketone-alcohol oil 148 in order to form adipic acid 114. Ketone-alcohol oil 148 can be formed from circular oil or circular naphtha 150. The circular oil or naphtha, for instance, can be derived from biomasses described above. As shown in FIG. 9, the circular oil or naphtha can be converted into benzene 151 or phenol 152. The benzene 151 is then combined with hydrogen 154 to form cyclohexane 156. Alternatively, the phenol 152 can be combined with hydrogen 154 to form the ketone-alcohol oil 148. The hydrogen 154, in one aspect, can be derived from the circular methane 120. The cyclohexane 156 is combined with oxygen 158 to form the ketone-alcohol oil 148.

The nitric acid 146 is then combined with the ketone-alcohol oil 148 to produce the second monomer 114 or adipic acid. Adipic acid may be formed by the oxidation of ketone-alcohol oil with nitric acid. Ketone-alcohol oil is a blend containing ketones and alcohols, particularly of cyclonexanol and/or cyclohexanone. In the oxidation of ketone-alcohol oil, nitric acid in the concentration range of 50-60% may be used. The reaction is carried out in the presence of a catalyst, often a copper/ammonium metavanadate catalyst. This process usually results in by-products, including nitrous oxide and hydrogen gas which may optionally be reused or recycled. The reaction is typically run at a temperature of greater than 150 degrees Fahrenheit, such as greater than 250 degrees Fahrenheit, such as greater than 350 degrees Fahrenheit, such as greater than 450 degrees Fahrenheit. Additionally, the synthesis of adipic acid from ketone-alcohol oil and nitric acid is often conducted at pressures greater than atmospheric pressure, such as greater than 5 atmospheres, such as greater than 10 atmospheres, such as greater than 15 atmospheres or such as greater than 20 atmospheres.

Adipic acid 114 made in accordance with the present disclosure as shown in FIG. 9 can have a circular atom content of greater than about 20%, such as greater than about 25%, such as greater than about 30%, such as greater than about 35%, such as greater than about 40%. The circular atom content of the adipic acid is generally less than about 99%, such as less than about 80%.

Polyamide polymers made according to the present disclosure can have excellent physical and mechanical properties and can contain little to no impurities.

Once produced, the polyamide polymers can be combined with various additives and ingredients for producing compounded polymer compositions. The compounded polymer compositions are then well suited for producing various articles through molding processes, such as injection molding.

In one embodiment, the polyamide polymer can be combined with a flame retardant package. In one aspect, the flame retardant composition can contain a metal phosphinate optionally in combination with a metal phosphite and/or a nitrogen-containing synergist.

The metal phosphinate, for instance, may be a dialkyl phosphinate and/or a diphosphinate. The metal phosphinate may have one of the following chemical structures:

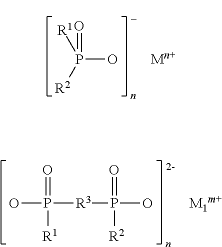

in which R1, R2 are the same or different and are each linear or branched C1-C6-alkyl; R3 is linear or branched C1-C10-alkylene, C6-C10-arylene, C7-C20-alkylarylene or C7-C20-arylalkylene; M is Mg, Ca, Al, Sb, Sn, Ge, Ti, Zn, Fe, Zr, Ce, Bi, Sr, Mn, Li, Na, K and/or a protonated nitrogen base; m is 1 to 4; n is 1 to 4; x is 1 to 4.

In one embodiment, the metal phosphinate is a metal dialkylphosphinate, such as aluminum diethylphosphinate. The metal phosphinate can be present in the polymer composition generally in an amount greater than about 5% by weight, such as in an amount greater than about 7% by weight, such as in an amount greater than about 9% by weight, such as in an amount greater than about 11% by weight, and generally in an amount less than about 30% by weight, such as in an amount less than about 25% by weight, such as in an amount less than about 20% by weight, such as in an amount less than about 17% by weight, such as in an amount less than about 14% by weight. In one embodiment, the metal phosphinate is present in the polymer composition in an amount from about 7% to about 20% by weight. In an alternative embodiment, the metal phosphinate is present in the polymer composition in an amount less than about 18% by weight, such as less than about 17% by weight, such as less than about 16% by weight, such as less than about 15% by weight, such as less than about 14% by weight.

In one embodiment, a metal phosphite can be optionally present in the polymer composition with a phosphinate and can comprise any suitable metal phosphite made from any of the metals (M) identified above. In one aspect, the metal phosphite is an aluminum phosphite. The aluminum phosphite can have the following chemical structure: Al2(HPO3)3. Other forms of aluminum phosphite may also be present in the polymer composition. Such other forms include basic aluminum phosphite, aluminum phosphite tetrahydrate, and the like. In still another embodiment, the aluminum phosphite may have the formula: Al(H2PO3)3.

The weight ratio between the metal phosphinate and the metal phosphite can generally be from about 10:8 to about 30:1, such as from about 10:1 to about 20:1, such as from about 14:1 to about 18:1. In one aspect, the metal phosphite may be present in the polymer composition in an amount greater than about 0.01% by weight, such as in an amount greater than about 0.1% by weight, such as in an amount greater than about 0.2% by weight, such as in an amount greater than about 0.3% by weight, and generally in an amount less than about 4% by weight, such as in an amount less than about 2.5% by weight, such as in an amount less than about 2% by weight, such as in an amount less than about 1.1% by weight. In one embodiment, the polymer composition is free of metal phosphite and only contains metal phosphinate.

A nitrogen-containing synergist may also be optionally present in combination with the metal phosphinate. For instance, the nitrogen-containing synergist may comprise a melamine, such as melamine cyanurate. Other melamine compounds that may be used include melam, melem, melon, melamine polyphosphate, dimelamine polyphosphate, melem polyphosphate, melam polyphosphate, melon polyphosphate, and the like. Other nitrogen-containing synergists that may be used include benzoguanamine, tris(hydroxyethyl) isocyanurate, allantoin, glycoluril, guanidine, or mixtures thereof. In general, only small amounts of the nitrogen-containing synergists need to be present in the polymer composition. For instance, the nitrogen-containing synergists can be present in the polymer composition in an amount less than about 12% by weight, such as in an amount less than about 11% by weight, such as in an amount less than about 10% by weight, such as in an amount less than about 9% by weight, such as in an amount less than about 8.5% by weight, and generally in an amount greater than about 0.1% by weight, such as in an amount greater than about 1.4% by weight, such as in an amount greater than about 3% by weight, such as in an amount greater than about 4% by weight. In one embodiment, the polymer composition is free of nitrogen-containing synergists and only contains metal phosphinate.

The polymer composition can also contain other flame retardants such as a zinc compound including zinc borate, zinc sulfite, and/or boehmite in amounts of from about 0.1% by weight to about 4% by weight.

In one embodiment, the polyamide polymers can be combined with reinforcing fibers, such as inorganic fibers.

The inorganic fibers generally have a high degree of tensile strength relative to their mass. For example, the ultimate tensile strength of the fibers (determined in accordance with ASTM D2101) is typically from about 1,000 to about 15,000 MPa, in some embodiments from about 2,000 MPa to about 10,000 MPa, and in some embodiments, from about 3,000 MPa to about 6,000 MPa. The high strength fibers may be formed from materials that are also electrically insulative in nature, such as glass, ceramics (e.g., alumina or silica), etc., as well as mixtures thereof. Glass fibers are particularly suitable, such as E-glass, A-glass, C-glass, D-glass, AR-glass, R-glass, S1-glass, S2-glass, etc., and mixtures thereof. The inorganic fibers may have a relatively small median diameter, such as about 50 micrometers or less, in some embodiments from about 0.1 to about 40 micrometers, and in some embodiments, from about 2 to about 20 micrometers, such as determined using laser diffraction techniques in accordance with ISO 13320:2009 (e.g., with a Horiba LA-960 particle size distribution analyzer). It is believed that the small diameter of such fibers can allow their length to be more readily reduced during melt blending, which can further improve surface appearance and mechanical properties. After formation of the polymer composition, for example, the average length of the inorganic fibers may be relatively small, such as from about 10 to about 800 micrometers, in some embodiments from about 100 to about 700 micrometers, and in some embodiments, from about 200 to about 600 micrometers. The inorganic fibers may also have a relatively high aspect ratio (average length divided by nominal diameter), such as from about 1 to about 100, in some embodiments from about 10 to about 60, and in some embodiments, from about 30 to about 50.

In one aspect, glass fibers can be present in the polymer composition in an amount from about 5% by weight to about 65% by weight. For instance, glass fibers can be present in an amount greater than about 15% by weight, such as in an amount greater than about 20% by weight, such as in an amount greater than about 25% by weight, and in an amount less than about 63% by weight, such as in an amount less than about 50% by weight.

In accordance with the present disclosure, the polymer composition contains one or more lubricants that are added in an amount sufficient to lower ejection forces of parts from a mold, such as a mold during injection molding. Alternatively, the one or more lubricants can be added in an amount sufficient to lower mold deposits, in comparison to an identical composition not containing the one or more lubricants.

In one aspect, the polymer composition contains a polar lubricant and/or an oxidized lubricant. Polar materials, for instance, blend well with the other components. The polar lubricant, for instance, can be an oxidized wax, such as an oxidized polyolefin wax or oxidized esters of carboxylic acids. The oxidized polyolefin wax, for instance, can be an oxidized polyethylene wax.

The polarity of the lubricant can vary depending upon the particular application and the desired result. The polarity, for instance, can be indicated by the acid value of the lubricant. The acid value of the polar lubricant, for instance, can generally be greater than about 10 KOH/g, such as greater than about 15 KOH/g, such as greater than about 20 KOH/g, such as greater than about 25 KOH/g, such as greater than about 30 KOH/g, such as greater than about 35 KOH/g, such as greater than about 40 KOH/g, such as greater than about 45 KOH/g, such as greater than about 50 KOH/g. The acid value is generally less than about 95 KOH/g, such as less than about 90 KOH/g, such as less than about 85 KOH/g, such as less than about 80 KOH/g, such as less than about 75 KOH/g, such as less than about 70 KOH/g.

In one aspect, the acid value of the polar lubricant can be from about 13 KOH/g to about 23 KOH/g, such as from about 15 KOH/g to about 19 KOH/g. In an alternative embodiment, the acid value of the polar lubricant can be from about 40 KOH/g to about 65 KOH/g, such as from about 45 KOH/g to about 55 KOH/g.

As described above, in one embodiment, the polar lubricant can be oxidized esters of carboxylic acids. In one aspect, the oxidized esters of carboxylic acids can be derived from biomass materials, such as rice bran.

The different carboxylic acids used to produce the oxidized esters of fatty acids can vary depending upon the source of the fatty acids and the desired result. In one embodiment, the oxidized esters of fatty acids can be derived from at least three different fatty acids, such as at least five different fatty acids, such as at least about eight different fatty acids, and generally less than about 20 different fatty acids, such as less than about 15 different fatty acids. The fatty acids used to produce the oxidized esters, for instance, can have various different chain lengths. For instance, of all the fatty acids present in the oxidized wax, greater than about 20% by weight, such as greater than about 30% by weight, such as greater than about 40% by weight, such as greater than about 50% by weight, such as greater than about 60% by weight, can be derived from fatty acids having a carbon chain length of from about 20 carbon atoms to about 40 carbon atoms. The oxidized wax can also be derived from longer chain fatty acids. For instance, the oxidized wax can be derived from greater than about 5% by weight, such as greater than about 10% by weight, such as greater than about 15% by weight, such as greater than about 20% by weight, such as greater than about 25% by weight, such as greater than about 30% by weight, such as greater than about 40% by weight, such as greater than about 45% by weight, such as greater than about 50% by weight of fatty acids having a carbon chain length of from about 40 carbon atoms to about 64 carbon atoms. The above carboxylic acids can be aliphatic carboxylic acids. In one aspect, the oxidized wax contains less than about 5% by weight of esters derived from fatty acids having a carbon chain length of less than about 14 carbon atoms, such as less than about 12 carbon atoms, such as less than about 10 carbon atoms, such as less than about 8 carbon atoms.

In one embodiment, the lubricant can be fatty acid esters derived from montanic waxes. For instance, the lubricant can contain montanic acids partially esterified with butylene glycol and montanic acids partially saponified with calcium hydroxide. In one embodiment, the lubricant contains montanic acids esterified with ethylene glycol or glycerol.

The lubricant may also be formed from a fatty acid salt derived from fatty acids having a chain length of from 22 to 38 carbon atoms, and in some embodiments, from 24 to 36 carbon atoms. Examples of such fatty acids may include long chain aliphatic fatty acids, such as montanic acid (octacosanoic acid), arachidic acid (arachic acid, icosanic acid, icosanoic acid, n-icosanoic acid), tetracosanoic acid (lignoceric acid), behenic acid (docosanoic acid), hexacosanoic acid (cerotinic acid), melissic acid (triacontanoic acid), erucic acid, cetoleic acid, brassidic acid, selacholeic acid, nervonic acid, etc. For example, montanic acid has an aliphatic carbon chain of 28 atoms and arachidic acid has an aliphatic carbon chain of 20 atoms. Due to the long carbon chain provided by the fatty acid, the lubricant has a high thermostability and low volatility. This allows the lubricant to remain functional during formation of the desired article to reduce internal and external friction, thereby reducing the degradation of the material caused by mechanical/chemical effects.

The fatty acid salt may be formed by saponification of a fatty acid wax to neutralize excess carboxylic acids and form a metal salt. Saponification may occur with a metal hydroxide, such as an alkali metal hydroxide (e.g., sodium hydroxide) or alkaline earth metal hydroxide (e.g., calcium hydroxide). The resulting fatty acid salts typically include an alkali metal (e.g., sodium, potassium, lithium, etc.) or alkaline earth metal (e.g., calcium, magnesium, etc.). Such fatty acid salts generally have an acid value (ASTM D 1386) of about 20 mg KOH/g or less, in some embodiments about 18 mg KOH/g or less, and in some embodiments, from about 1 to about 15 mg KOH/g. Particularly suitable fatty acid salts for use in the present invention are derived from crude montan wax, which contains straight-chain, unbranched monocarboxylic acids with a chain length in the range of C28-C32.

In addition to polar materials, effective lubricants can also comprise non-polar materials, such as non-polar polymers. Non-polar polymers, for example, can migrate to the surface of polymer articles made from the polymer composition during molding. In this manner, non-polar polymer materials in accordance with the present disclosure can significantly reduce the amount of force needed in order to eject a part from a mold. Non-polar polymers that may be used in accordance with the present disclosure include various different non-polar polyolefin polymers, including polyethylene polymers and polypropylene polymers. The polyolefin polymer can be a homopolymer or a copolymer. In one embodiment, the non-polar polymer can be a polyethylene wax.

Other known waxes may also be employed in a lubricant. Amide waxes, for instance, may be employed that are formed by reaction of a fatty acid with a monoamine or diamine (e.g., ethylenediamine) having 2 to 18, especially 2 to 8, carbon atoms. For example, ethylene-bis-amide wax, which is formed by the amidization reaction of ethylene diamine and a fatty acid, may be employed. The fatty acid may be in the range from C12 to C30, such as from stearic acid (C18 fatty acid) to form ethylene-bis-stearylamide wax. Other ethylene-bisamides include the bisamides formed from lauric acid, palmitic acid, oleic acid, linoleic acid, linolenic acid, oleostearic acid, myristic acid and undecanic acid. Still other suitable amide waxes are N-(2-hydroxyethyl) 12-hydroxystearamide and N,N′-(ethylene bis) 12-hydroxystearamide.

Each lubricant can be present in the polymer composition generally in an amount less than about 2% by weight, such as in an amount less than about 1% by weight, such as in an amount less than about 0.8% by weight, such as in an amount less than about 0.6% by weight, such as in an amount less than about 0.4% by weight, such as in an amount less than about 0.2% by weight. The one or more lubricants are generally present in the polymer composition in an amount greater than about 0.01% by weight.

A wide variety of additional additives can also be included in the polyamide composition, such as impact modifiers, compatibilizers, particulate fillers (e.g., mineral fillers), lubricants, pigments, antioxidants, light stabilizers, heat stabilizers, and/or other materials added to enhance properties and processability. In certain embodiments, for example, the composition may contain a UV stabilizer. Suitable UV stabilizers may include, for instance, benzophenones, benzotriazoles (e.g., 2-(2-hydroxy-3,5-di-α-cumylphenyl)-2H-benzotriazole (TINUVIN® 234), 2-(2-hydroxy-5-tert-octylphenyl)-2H-benzotriazole (TINUVIN® 329), 2-(2-hydroxy-3-α-cumyl-5-tert-octylphenyl)-2H-benzotriazole (TINUVIN® 928), etc.), triazines (e.g., 2,4-diphenyl-6-(2-hydroxy-4-hexyloxyphenyl)-s-triazine (TINUVIN® 1577)), sterically hindered amines (e.g., bis(2,2,6,6-tetramethyl-4-piperidyl) sebacate (TINUVIN® 770) or a polymer of dimethyl succinate and 1-(2-hydroxyethyl)-4-hydroxy-2,2,6,6-tetramethyl-4-piperidine (TINUVIN®622)), and so forth, as well as mixtures thereof. When employed, such UV stabilizers typically constitute from about 0.05 wt. % to about 2 wt. % in some embodiments from about 0.1 wt. % to about 1.5 wt. %, and in some embodiments, from about 0.2 wt. % to about 1.0 wt. % of the composition.

In one embodiment, the polymer composition contains a heat stabilizer. The heat stabilizer, for instance, can comprise dipentaerythritol. The heat stabilizer can be present in the polymer composition in an amount greater than about 0.3% by weight, such as in an amount greater than about 0.5% by weight, such as in an amount greater than about 0.7% by weight, such as in an amount greater than about 1% by weight, such as in an amount greater than about 1.2% by weight, such as in an amount greater than about 1.4% by weight, and in an amount less than about 5% by weight, such as in an amount less than about 3% by weight, such as in an amount less than about 2% by weight, such as in an amount less than about 1.8% by weight.

In one aspect, a flow modifier can be present in the composition. The flow modifier can comprise naphthalic acid for increasing the melt flow rate of the composition. The flow modifier can be present in the composition in an amount of from about 0.001% by weight to about 2% by weight, such as from about 0.01% by weight to about 0.8% by weight.

In addition to the above components, the polymer composition may include various other ingredients. Colorants that may be used include any desired inorganic pigments, such as titanium dioxide, ultramarine blue, cobalt blue, and other organic pigments and dyes, such as phthalocyanines, anthraquinones, and the like. Other colorants include various other polymer-soluble dyes. The colorants can generally be present in the composition in an amount up to about 2 percent by weight.

In general, other additives and fillers, processing stabilizers, lubricants, and the like can be present in the polymer composition in an amount from about 0.01% by weight to about 60% by weight.

Shaped parts may be formed from the polyamide composition using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, blow molding, rotational molding, extrusion molding, foam extrusion molding, compression molding, foam compression molding, gas compression molding, etc. For example, an injection molding system may be employed that includes a mold within which the polyamide composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polyamide composition into the desired article also occurs within a mold. The composition may be placed into the compression mold using any known technique, such as by being picked up by an automated robot arm. The temperature of the mold may be maintained at or above the solidification temperature of the polymer matrix for a desired time period to allow for solidification. The molded product may then be solidified by bringing it to a temperature below that of the melting temperature. The resulting product may be de-molded. The cycle time for each molding process may be adjusted to suit the polymer matrix, to achieve sufficient bonding, and to enhance overall process productivity.

The polyamide polymers of the present disclosure can be used to produce all different types of products and components. For instance, the polyamide polymers can be used to make all different types of automotive parts including engine components such as gears, bearings, and other mechanical parts and interior components such as seatbelts, airbag containers, and upholstery. The polyamide polymers can also be used to in industrial applications to produce machinery parts such as gears, bearings, and bushings, electrical components such as cable ties, electrical insulators, and connectors, and filtration systems such as filters and screens in industrial applications.

Particular products and components that can be made from the polyamide polymers of the present disclosure include anti-vibration and suspension systems, traction motors, clips, clamps, body plugs, grommets, cable ties, end caps, propulsion cooling systems, air management systems, cockpit components, high speed data and low voltage connectors, wire and cables, oil management systems, exterior trims and parts, engine parts, closures and fasteners, power electronics, rail and train systems, steering systems, charging plug and socket components, injection device components, traction motor components, circuit breakers and contactors, storage tanks and vessels, solar photovoltaic components, furniture components, brake system components, transmission components, wheeled sport components, switches, pedals and gear shift systems, door components, fluid management parts, tubes, hoses, and pipes, oil management components, sockets, plumbing hardware, relays, fuses and switches, filaments, fibers and fabrics, fuel cell components, military, weapons and munition components, sensors, tools, motorcycle parts, safety restraint systems, coil form and transformer parts, front and rear end module components, conveyor chains and belts, relays, fuel supply system components, seats and seating system components, ADAS (Advanced Driver Assistance Systems) components, agriculture and mining parts, footwear, medical packaging, server parts, air conditioning parts, ropes, cordage, nettings, lithium-ion battery components, water management (irrigation and drainage) components, windshield wiper and washer system components, 5G base station components, tabletop computer components, automation and robotic (Drones, AMR, AGV) systems parts and components, and the like.

The polyamide polymers are particularly well suited for use in electric vehicles to make battery components and housings, electrical connectors, terminal blocks, and other electrical components.

For example, the present inventors have discovered that the polyamide polymers are particularly suitable for use in electrical connectors, such as those employed in electric vehicles and household appliances. The connector may contain insertion passageways that are configured to receive contact pins. These passageways are defined by opposing walls, which may be formed from the polyamide composition of the present invention. The walls may have a width of from about 500 micrometers or less, in some embodiments from about 100 to about 450 micrometers, and in some embodiments, from about 200 to about 400 micrometers.

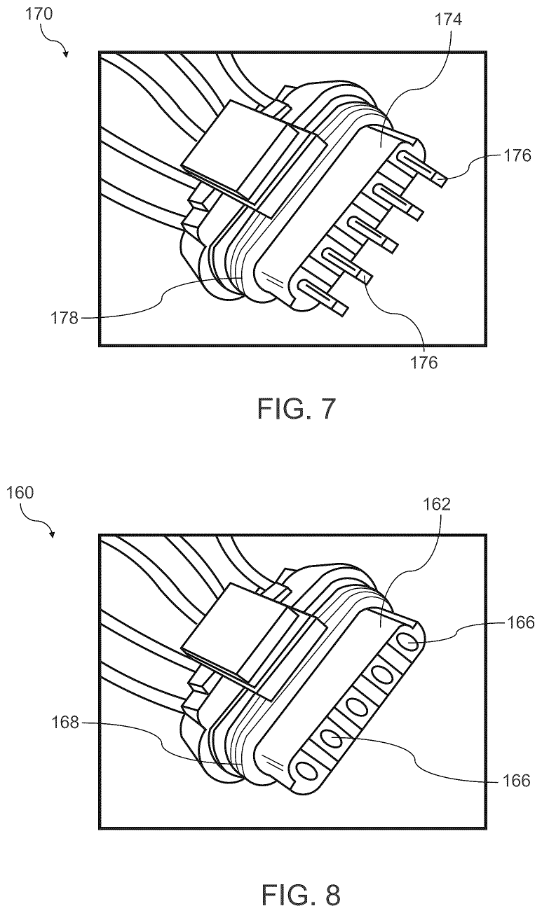

Referring to FIGS. 7 and 8, embodiments of electrical connectors that can be made in accordance with the present disclosure are shown.

Referring to FIG. 7, one embodiment of a high-voltage connector 170 that may be made in accordance with the present disclosure is shown. The electrical connector 170 includes a plurality of contact elements 176 extending from a base 174. The contact elements 176 are for making an electrical connection to an opposing connector. In the embodiment illustrated in FIG. 7, the contact elements 176 are male contacts that are to be inserted into opposing receptors.

As shown in FIG. 7, the connector 170 further includes a gasket 178. The gasket 178 is for providing a fluid-tight connection when the connector is engaged with a complementary receptacle. The gasket can be made from any suitable elastomer or rubber. In one aspect, for instance, the gasket 178 is made from a silicone elastomer.

Referring to FIG. 8, another connector 160 made in accordance with the present disclosure is shown. The connector 160 is for receiving and attaching to the connector 170 as shown in FIG. 7. The connector 160 includes a base 162 that surrounds and forms walls around a plurality of contact elements 166. The contact elements 166 are female connectors for receiving the male contact elements 176 from connector 170 as shown in FIG. 7. As shown, the connector 160 also includes a gasket 168 similar to the embodiment illustrated in FIG. 7.

In accordance with the present disclosure, the base 174 of the connector 170 and the base 162 of the connector 160 can be made from the polymer composition of the present disclosure.

### Example 1

A polymer composition containing glass fibers and a flame retardant package was formulated in accordance with the present disclosure and tested for various properties. The polyamide polymer included in the composition had a circular carbon content of about 20%. The following results were obtained.

TABLE 1

| | Norm | | |
|---|---|---|---|
| Formulation | ISO | Unit | 1 |
| Polyamide 6T/66 | | % | 51 |
| Glass fibers | | % | 34.93 |
| Aluminum diethylphosphinate | | % | 9.98 |
| Boehmite | | % | 1.59 |
| Montan wax | | % | 0.2 |
| Zinc borate | | % | 0.3 |
| Black masterbatch | | % | 1 |
| Naphthalic acid | | % | 1 |
| Stress at Break (DAM) | 527-2 | MPa | 148 |
| Stress at Break 80 C. | 527-2 | MPa | 118 |
| Stress at Break 120 C. | 527-2 | MPa | 89 |
| Stress at Break 150 C. | 527-2 | MPa | 78 |
| Stress at Break 180 C. | 527-2 | MPa | 69 |
| Elongation at break (DAM) | 527-2 | % | 1.7 |
| Elongation at break 80 C. | 527-2 | % | 1.9 |
| Elongation at break 120 C. | 527-2 | % | 3.4 |
| Elongation at break 150 C. | 527-2 | % | 4.1 |
| Elongation at break 180 C. | 527-2 | % | 4.5 |
| Tensile modulus (DAM) | 527-2 | MPa | 12525 |
| Tensile modulus 80 C. | 527-2 | MPa | 10700 |
| Tensile modulus 120 C. | 527-2 | MPa | 7248 |
| Tensile modulus 150 C. | 527-2 | MPa | 6388 |
| Tensile modulus 180 C. | 527-2 | MPa | 5547 |
| Notched Charpy | 179/1 eU | kJ/m² | 6.5 |
| Unnotched Charpy | 179/1 eU | kJ/m² | 40 |
| MV 1000 Hz 250° C. (Pa-s) | 1144-3 | Pa · s | 84.8 |
| UL 94 unaged (0.8 mm) | | | V0 |
| UL 94 aged (0.8 mm) | | | V0 |
| HDT @ 1.8 MPa | 75-1/-2 | C. | 285.7 |
| GWFI (0.8 mm) | | C. | 960 |
| GWIT (0.8 mm) | | C. | 750 |
| CIE L | | | 34.62 |
| CIE a | | | −1.16 |
| CIE b | | | −3.32 |
| CIE DL | | | −0.11 |
| CEI Da | | | 0.04 |
| CEI Db | | | −0.25 |

The polymer composition was tested for dimensional stability. A dimensional stability test was performed on 60 mm×60 mm×2 mm plates to evaluate shrinkage after repeated thermal cycling at high temperature. The procedure was as follows:
1. Initial measurement—Each plate's dimensions (flow and cross-flow directions) were measured at room temperature.
2. First heating cycle—Plates were placed in an oven at
3. Cooling—Plates cooled in the oven for 2 hours.
4. Second heating cycle—Plates were reheated to 190° C. quickly and held for 2 hours.
5. Cooling—Plates cooled in the oven for 2 hours.
6. Third heating cycle—Plates were reheated to 190° C. quickly and held for 2 hours.
7. Final cooling—Plates were cooled for 24 hours at ambient temperature.
8. Final measurement—Plate dimensions were measured again (flow and cross-flow directions) and Shrinkage (%) in each direction was calculated.

The following results were obtained (average result of 5 samples). A shrinkage of only 0.25% was recorded in the flow direction and a shrinkage of only 0.32% was recorded in the cross flow direction.

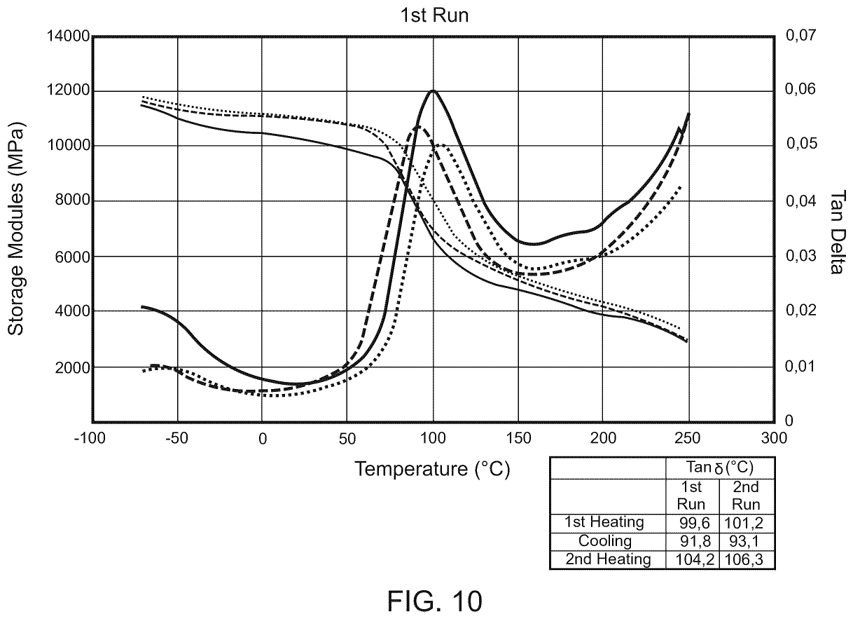

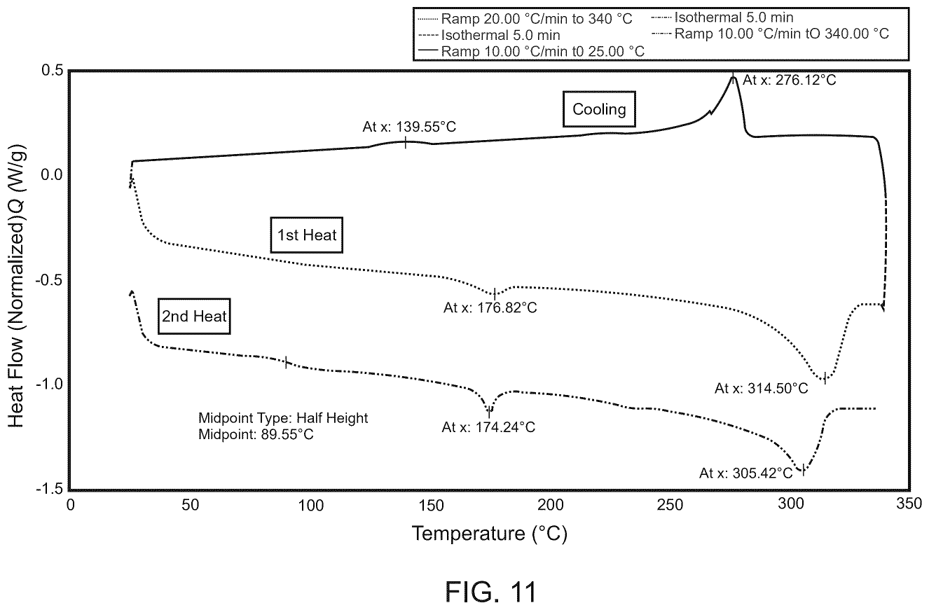

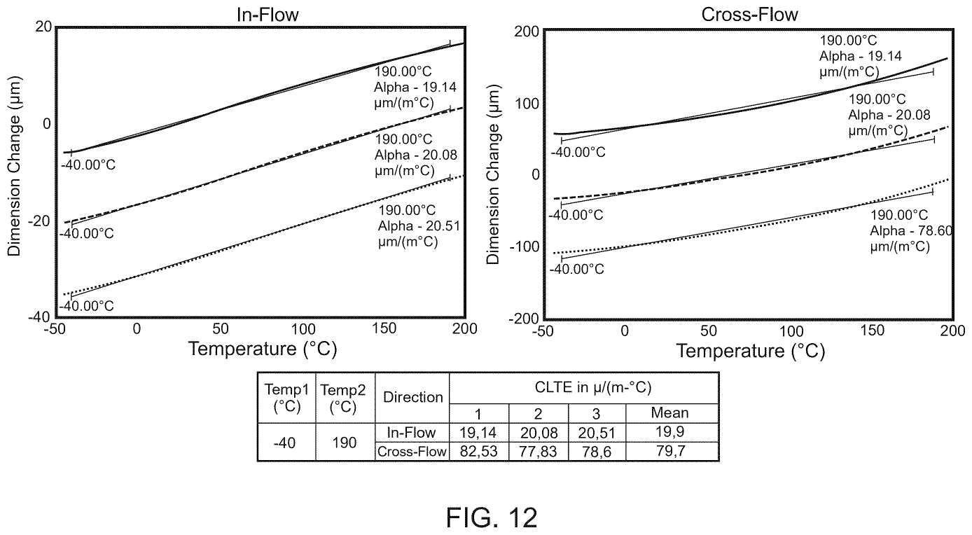

FIG. 10 illustrates the results of a dynamic mechanical analysis (DMA) test. FIG. 11 illustrates the results of a differential scanning calorimetry (DSC) test. FIG. 12 illustrates the results of a Coefficient of Linear Thermal Expansion (CLTE) using Thermomechanical Analysis (TMA) test.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims

What is claimed:

1. A method for producing a polyamide polymer comprising:
forming a polyamide polymer from a first monomer and a second monomer, the first monomer comprising a diamine, the second monomer comprising an aliphatic diacid comprising decanedioic acid, sebacic acid, dodecanedioic acid, or mixtures thereof, an aromatic diacid containing 8 to 20 carbon atoms, or mixtures thereof, wherein at least a portion of the first monomer is derived from a circular atom component, the circular atom component comprising a circular natural gas, and wherein the resulting polyamide polymer has a circular atom content of at least about 10% by weight.

2. A method as defined in claim 1, wherein the resulting polyamide polymer has a circular atom content of at least about 14% by weight.

3. A method as defined in claim 1, wherein the circular atom content is determined according to ISCC.

4. A method as defined in claim 1, wherein the circular natural gas comprises a circular methane containing methane in an amount greater than about 80% by weight.

5. A method as defined in claim 1, wherein the first monomer comprises hexamethylene diamine.

6. A method as defined in claim 1, wherein the first monomer comprises decamethylene diamine.

7. A method as defined in claim 1, wherein the second monomer comprises terephthalic acid, decanedioic acid, dodecanedioic acid, isophthalic acid, sebacic acid, or mixtures thereof.

8. A method as defined in claim 1, wherein the polyamide polymer comprises a homopolymer of polyamide 6T or a copolymer or terpolymer comprising polyamide 6T/6I, polyamide 6T/66, polyamide 6T/610, polyamide 6I/6T, polyamide 6T/DT, polyamide 610, or polyamide 612, polyamide 6T/6I/66, polyamide 6T/6I/6, polyamide 6/66/10, polyamide 6/66/12, or polyamide 6/612.

9. A method as defined in claim 1, wherein the circular natural gas is steam reformed to produce hydrogen which is combined with nitrogen gas to form ammonia, the ammonia being combined with additional amounts of the circular natural gas to form hydrogen cyanide, the hydrogen cyanide being used to form adiponitrile, the adiponitrile being hydrogenated to form the first monomer.

10. A method as defined in claim 9, wherein the adiponitrile is hydrogenated with hydrogen captured during the production of hydrogen cyanide.

11. A method as defined in claim 9, wherein the ammonia comprises blue ammonia, green ammonia, or turquoise ammonia.

12. A method as defined in claim 9, wherein the adiponitrile is formed by hydrocyanation of 1,3 butadiene.

13. A method as defined in claim 12, wherein the 1,3 butadiene is formed from a circular carbon component comprising a circular oil or a circular naphtha.

14. A method as defined in claim 1, wherein the circular natural gas is steam reformed to produce hydrogen which is combined with nitrogen gas to form ammonia, the ammonia being combined with oxygen and propylene to form acrylonitrile, the acrylonitrile being converted to adiponitrile, which is hydrogenated to form the first monomer.

15. A method as defined in claim 14, wherein the propylene is derived from a circular carbon component comprising the circular natural gas.

16. A method as defined in claim 1, wherein the circular natural gas is converted to methanol for producing an olefin, the olefin being combined with a butadiene to produce adiponitrile which is hydrogenated to form the first or second monomer.

17. A method as defined in claim 16, wherein the butadiene is formed from a circular carbon component comprising a circular oil or a circular naphtha.

18. A method as defined in claim 1, wherein the polyamide polymer is combined with glass fibers, the glass fibers being present in the resulting polymer composition in an amount of from about 5% by weight to about 65% by weight.

19. A method as defined in claim 1, wherein the polyamide polymer is molded into an article.

20. A method as defined in claim 19, wherein the molded article comprises an electrical connector or an automotive engine part.

21. A method as defined in claim 1, wherein the second monomer comprises terephthalic acid and wherein the terephthalic acid is formed from a circular p-xylene through an oxidation reaction.

22. A method as defined in claim 21, wherein the p-xylene is formed from biomass or recycled polyolefins.

23. A method as defined in claim 6, wherein ammonia is combined with decanedioic acid to form decanediamide, the decanediamide being dehydrated to form sebaconitrile, the sebaconitrile being combined with hydrogen to form the diamine monomer.

24. A polymer composition comprising:
a polyamide polymer formed from a first monomer and a second monomer, the first monomer comprising a diamine, the second monomer comprising an aliphatic diacid comprising decanedioic acid, sebacic acid, dodecanedioic acid, or mixtures thereof, an aromatic diacid containing 8 to 20 carbon atoms, or mixtures thereof, wherein at least a portion of the first monomer is derived from a circular atom component, and wherein the polyamide polymer has a circular atom content of at least about 10% by weight, the polyamide polymer being present in the polymer composition in an amount of at least about 15% by weight;
optionally reinforcing fibers;
a flame retardant composition; and
a lubricant.
